(19) United States
(12) Patent Application Publication
(10) Pub. No.: US 2017/0051897 A1
(43) Pub. Date: Feb. 23, 2017

(54) LIGHT SOURCE DEVICE, ILLUMINATION DEVICE, AND PROJECTOR

(71) Applicant: Seiko Epson Corporation, Tokyo (JP)

(72) Inventor: Takahiro Takizawa, Suzaka-shi (JP)

(21) Appl. No.: 15/233,822

(22) Filed: Aug. 10, 2016

(30) Foreign Application Priority Data
Aug. 20, 2015 (JP) 2015-162514
Aug. 20, 2015 (JP) 2015-162515

(51) Int. Cl. F21V 19/00; F21V 7/04; F21V 29/67; G03B 21/20; G03B 21/16

(52) U.S. Cl. CPC F21V 19/0075; G03B 21/2093; G03B 21/16; F21V 29/673; G03B 21/2066; F21V 7/04; G03B 21/006

(57) ABSTRACT

An illumination device includes a light source device, an attachment member to which the light source device is attached, and a first fixture inserted into the light source device to fix the light source device to the attachment member. The light source device includes a light source and a housing configured to house the light source on the inside. The housing includes a first housing and a second housing combined with each other to house the light source on the inside, and a second fixture inserted into the first housing and the second housing to fix the first housing and the second housing in a combined state. A removing direction of the first fixture and a removing direction of the second fixture with respect to the light source device are different.

### CROSS REFERENCE TO RELATED APPLICATION

The entire disclosures of Japanese Patent Application No. 2015-162514 filed Aug. 20, 2015, and Japanese Patent Application No. 2015-162515 filed Aug. 20, 2015, are expressly incorporated by reference herein.

### BACKGROUND

1. Technical Field

The present invention relates to a light source device, an illumination device, and a projector.

2. Related Art

There has been known a projector including a light source device, a light modulating device that modulates light emitted from the light source device and forms an image corresponding to image information, and a projecting optical device that enlarges and projects the formed image on a projection surface such as a screen (see, for example, JP-A-2011-181431 (Patent Literature 1) and JP-A-2009-211975 (Patent Literature 2)).

In the projector described in Patent Literature 1, the light source device includes a light-source-device main body including a luminous tube and a reflecting mirror, a collimating lens, a housing that houses the light-source-device main body and the collimating lens on the inside, and a channel switching mechanism. Among these components, the housing is configured by combining a cylindrical member that covers the front side of the reflecting mirror and a blocking member that covers the rear side of the reflecting mirror.

On the other hand, in the projector described in Patent Literature 2, the light source device includes a light-source-device main body including a light source lamp and a reflector that aligns lights emitted from the light source lamp in a fixed emitting direction, a collimating lens that collimates the lights aligned in the emitting direction by the reflector, and a housing that houses the light-source-device main body and the collimating lens on the inside. Among these components, an opening end edge of the reflector is formed in a substantially rectangular shape when viewed from the emitting direction side of the lights.

The housing includes a first housing disposed on the emitting direction side of the lights emitted by the light-source-device main body, a second housing disposed on the opposite side of the emitting direction, and an urging member disposed to be interposed between the first housing and the second housing to urge the light-source-device main body to the first housing side. The first housing, the second housing, and the urging member are integrated by screws.

Incidentally, the light source device needs to be replaced because of the rupture, the life, or the like of the luminous tube. In such a case, when the light source device is directly attached to a light-source housing member in the projector, the light source device is detached from the light-source housing section and replaced. When a light-source attaching member attached with the light source device is detachably provided in the projector, after the light-source attaching member is detached from the projector, the light source device is detached from the light-source attaching member and replaced. In these configurations, when a light-source-device fixture for fixing the light source device to an attachment member (e.g., the light-source housing member or the light-source attaching member) and a housing fixture for fixing a plurality of members (e.g., the cylindrical member and the blocking member) configuring the housing of the light source device are visually recognized, an operator, who replaces the light source device, is likely to detach the housing fixture by mistake.

For easiness of attachment to the housing and a reduction in the size of a product, a square reflector having corners such as the reflector described in Patent Literature 2 is often adopted.

In order to improve light use efficiency of the light source lamp, a reflecting surface shape of the reflector needs to be optimized. However, in the case of the square reflector, since a part of a reflecting surface is formed in a plane shape, it is difficult to condense lights reflected in the part and align the lights in one direction. As a result, the light use efficiency is deteriorated. Since the thickness of the reflector is unequal, it is likely that the reflecting surface warps. Therefore, difficulty in machining and assembly of components increases.

On the other hand, it is conceivable to make it easy to condense the reflected lights and align the reflected lights in one direction, equalize the thickness of the reflector, and improve the light use efficiency and easiness of manufacturing by adopting a round reflector, a plane shape portion of which is smaller than the plane shape portion of the square reflector.

However, in the round reflector, because of a curved surface shape thereof, it is difficult to position and fix the round reflector with respect to the housing.

### SUMMARY

An advantage of some aspects of the invention is to provide an illumination device and a projector from which a light source device can be appropriately detached and a light source device and a projector that can improve light use efficiency.

An illumination device according to a first aspect of the invention includes: alight source device; an attachment member to which the light source device is attached; and a first fixture inserted into the light source device and the attachment member to fix the light source device and the attachment member. The light source device includes: a light source; and a housing configured to house the light source on the inside. The housing includes: a first housing and a second housing combined with each other to house the light source on the inside; and a second fixture inserted into the first housing and the second housing to fix the first housing and the second housing. A removing direction of the first fixture and a removing direction of the second fixture with respect to the light source device are different.

Note that, as the first fixture and the second fixture, fastening members such as screws can be illustrated.

According to the first aspect, the removing direction of the first fixture for fixing the light source device to the attachment member and the removing direction of the second fixture for fixing the first housing and the second housing of the housing are different. Therefore, when the light source device is viewed from the removing direction side of the first fixture, it is possible to make it difficult to visually recognize the second fixture. Therefore, when the first fixture is removed and the light source device is detached from the attachment member, it is possible to suppress the second fixture from being removed. It is possible to appropriately detach the light source device.

In the first aspect, it is preferable that the first fixture is inserted into the light source device and the attachment member along a direction in which the attachment member is located with respect to the light source device, and the second fixture is inserted into the first housing and the second housing along the opposite direction of the inserting direction of the first fixture.

With such a configuration, the respective inserting directions of the first fixture and the second fixture are directions opposite to each other. Therefore, as explained above, when the light source device is viewed from the removing direction side of the first fixture, it is possible to make it more difficult to visually recognize the second fixture. Consequently, when the first fixture is removed and the light source device is detached from the attachment member, it is possible to surely suppress the second fixture from being removed. Therefore, it is possible to appropriately detach the light source device from the attachment member.

In the first aspect, it is preferable that the first housing is located on the attachment member side in the housing, the second housing is located on the opposite side of the attachment member in the housing, the first fixture is inserted into the attachment member from the second housing side, and the second fixture is inserted into the second housing from the first housing side.

With such a configuration, it is possible to surely set the respective inserting directions of the first fixture and the second fixture in opposite directions each other. In other words, it is possible to surely set the respective removing directions of the first fixture and the second fixture in opposite directions each other. Therefore, it is possible to more surely make it difficult to visually recognize the second fixture when the first fixture is removed. It is possible to surely suppress the second fixture from being removed.

In the first aspect, it is preferable that the first housing includes, on a surface opposed to the attachment member, an insertion hole into which the second fixture is inserted, and the second fixture inserted into the insertion hole is covered by the attachment member.

With such a configuration, in a state in which the light source device is attached to the attachment member, it is difficult to visually recognize the second fixture. Therefore, when the light source device is detached from the attachment member, it is possible to more surely suppress the second fixture from being removed. Therefore, it is possible to appropriately remove the light source device from the attachment member.

In the first aspect, it is preferable that the first housing includes a hole section through which the first fixture, which is inserted from the second housing side and fixed to the attachment member, is inserted.

If the hole section is located in the second housing apart from the attachment member, a dimension between the hole section and the attachment member is long. In this case, it is necessary to adopt a relatively long first fixture. Moreover, it is difficult to stably fix the light source device to the attachment member.

On the other hand, since the hole section is located in the first housing close to the attachment member compared with the second housing, it is possible to reduce the dimension between the hole section and the attachment member. Therefore, it is possible to adopt a relatively short first fixture. It is possible to stably fix the light source device to the attachment member.

In the first aspect, it is preferable that the first housing includes a projecting section projecting further to the outer side than the second housing when viewed from an attachment side of the light source device to the attachment member, and the hole section is located in the projecting section.

With such a configuration, since the hole section, through which the first fixture is inserted, is located in the projecting section projecting further to the outer side than the second housing, it is possible to easily insert and remove the first fixture on the attachment side of the light source device to the attachment member and it is possible to easily insert and remove the first fixture into and from the attachment member. Therefore, it is possible to easily attach and detach the light source device to and from the attachment member.

In the first aspect, it is preferable that the first housing is located on an emission side of light emitted by the light source device with respect to the second housing.

With such a configuration, the light source device is disposed such that the first housing located on the emission side of the light with respect to the second housing is close to the attachment member. Consequently, it is possible to easily carry out adjustment of an emitting position of the light with respect to the attachment member. Therefore, it is possible to easily and appropriately adjust a traveling direction of light emitted from an illumination device.

A projector according to a second aspect of the invention includes the illumination device.

With the second aspect, it is possible to achieve effects same as the effects of the illumination device according to the first aspect.

In the second aspect, it is preferable that the illumination device includes a plurality of the light source devices, and the projector includes an optical-path changing device configured to change optical paths of lights emitted from the plurality of light source devices and emit the lights.

With such a configuration, when the plurality of light source devices are attached to the attachment member and when a plurality of the attachment members attached with light source devices are provided, it is possible to align, with the optical-path changing device, the lights emitted from the light source devices in one direction and emit the lights. Therefore, it is possible to form an image effectively using the lights emitted from the light source devices and increase the luminance of the image to be projected.

A light source device according to a third aspect of the invention includes: a light emitting section; a reflector configured to reflect light made incident from the light emitting section; a housing configured to house the light emitting section and the reflector on the inside; and a fixing member configured to fix the reflector. The reflector is formed in a circular shape at an end edge when viewed from an emitting direction side of the light reflected and emitted by the reflector. The housing includes: an emission side housing located, with respect to the reflector, on an emitting direction side of the light reflected by the reflector; and a proximal-end side housing located on the opposite side of the emitting direction of the light and combined with the emission side housing. The fixing member is attached to the emission side housing in a state in which the reflector is fixed.

According to the third aspect, since the fixing member is attached to the emission side housing in the state in which the reflector formed in the circular shape at the end edge is fixed, it is possible to easily attach the reflector to the emission side housing. Therefore, it is easy to condense the reflected lights and align the reflected lights in one direction with the reflector and equalize the thickness of the reflector. Therefore, it is possible to improve use efficiency of the light emitted from the light emitting section. Besides, it is possible to improve easiness of manufacturing of the light source device.

In the third aspect, it is preferable that the reflector includes a convex section projecting toward the outer side, and the fixing member includes: an opening section into which the reflector is inserted; and a concave section located at the end edge of the opening section, the convex section fitting in the concave section.

With such a configuration, when the reflector is inserted into the opening section of the fixing member, the convex section of the reflector fits in the concave section of the fixing member. Consequently, it is possible to suppress the rotation of the reflector about an axis extending along the emitting direction of the light emitted by the reflector. Therefore, it is possible to stably attach the reflector to the emission side housing.

In the third aspect, it is preferable that the fixing member includes a pressing section configured to press the reflector inserted into the opening section to the concave section side.

With such a configuration, the pressing section of the fixing member presses the reflector to the concave section side in which the convex section fits. Therefore, it is possible to surely suppress the swing and the rotation of the reflector. Therefore, it is possible to more stably fix the reflector.

In the third aspect, it is preferable that the emission side housing includes a projecting section projecting to the fixing member side, and the fixing member includes an insertion section into which the projecting section is inserted.

With such a configuration, since the projecting section of the emission side housing is inserted into the insertion section of the fixing member, it is possible to accurately position the fixing member with respect to the emission side housing. Therefore, it is possible to attach the fixing member and the reflector to appropriate positions of the emission side housing.

In the third aspect, it is preferable that the fixing member includes an expanding/reducing section configured to expand and reduce the insertion section and cause the end edge of the insertion section to hold the projecting section.

With such a configuration, since the projecting section is held by the end edge of the insertion section expanded and reduced by the expanding/reducing section, it is possible to provisionally fix the fixing member to the emission side housing. Therefore, it is possible to more surely attach the fixing member and the reflector to appropriate positions of the emission side housing. Besides, it is possible to easily perform an attachment process for attaching the reflector and the fixing member to the emission side housing.

In the third aspect, it is preferable that the expanding/reducing section extends to the opposite side of the emission side housing in the fixing member, and the insertion section is expanded in diameter when the expanding/reducing section is displaced to the center side of the fixing member.

With such a configuration, when the expanding/reducing section is displaced to the center side of the fixing member, the insertion section is expanded in diameter and, when the expanding/reducing section is displaced to the opposite side of the center of the fixing member, the insertion section is reduced in diameter. Consequently, it is possible to easily expand and reduce the insertion section. It is possible to easily carry out operation for inserting the projecting section into the insertion section and operation for holding the projecting section inserted into the insertion section. Therefore, it is possible to easily provisionally fix the fixing member to the emission side housing.

In the third aspect, it is preferable that the fixing member includes: an insert-through hole through which a fixture for fixing the fixing member to the emission side housing is inserted; and a flexible section cut out and formed continuously to the insertion hole, the flexible section forming the end edge of the insert-through hole.

With such a configuration, even when tolerance occurs in a component dimension of at least one of the fixing member and the emission side housing, since the flexible section warps, it is possible to shift the position of the insert-through hole and absorb the tolerance. Therefore, it is possible to surely attach the fixing member to the emission side housing.

In the third aspect, it is preferable that the emission side housing includes: a main body section combined with the proximal-end side housing; and an air guide section disposed on the inner side of the main body section and configured to guide a cooling gas to the light emitting section, and the air guide section includes a step section in which an opening end edge of the reflector is fit.

With such a configuration, since the opening end edge of the reflector is fit in the step section of the air guide section, it is possible to suppress a leak of a cooling gas guided by the air guide section and efficiently guide the cooling gas to the light emitting section. Therefore, it is possible to improve cooling efficiency of the light emitting section.

A projector according to a fourth aspect of the invention includes the light source device.

According to the fourth aspect, it is possible to achieve effects same as the effects of the light source device according to the third aspect.

### BRIEF DESCRIPTION OF THE DRAWINGS

The invention will be described with reference to the accompanying drawings, wherein like numbers reference like elements.

FIG. 1 is a schematic perspective view showing a projector according to an embodiment of the invention.

FIG. 2 is a schematic diagram showing the internal configuration of the projector in the embodiment.

FIG. 3 is a perspective view showing an illumination device in the embodiment.

FIG. 4 is a plan view of the illumination device in the embodiment.

FIG. 5 is a perspective view showing a light-source attaching member to which a light source device in the embodiment is attached.

FIG. 6 is a perspective view showing the light-source attaching member from which the light source device in the embodiment is detached.

FIG. 7 is a perspective view showing a flow diverting member in the embodiment.

FIG. 8 is a perspective view showing the flow diverting member in the embodiment.

FIG. 9 is a perspective view showing the light source device in the embodiment.

FIG. 10 is a perspective view showing the light source device in the embodiment.

FIG. 11 is an exploded perspective view showing the light source device in the embodiment.

FIG. 12 is an exploded perspective view showing the light source device in the embodiment.

FIG. 13 is an exploded perspective view showing an intermediate member, a light source, and a fixing member in the embodiment.

FIG. 14 is an exploded perspective view showing the intermediate member, the light source, and the fixing member in the embodiment.

FIG. 15 is a diagram showing the intermediate member in the embodiment.

FIG. 16 is a diagram showing the intermediate member in the embodiment.

FIG. 17 is a sectional view showing a light source in the embodiment.

FIG. 18 is a diagram showing a reflector in the embodiment.

FIG. 19 is a diagram showing a fixing member in the embodiment.

FIG. 20 is a diagram showing the intermediate member attached with the light source and the fixing member in the embodiment.

FIG. 21 a diagram showing an intermediate member attached with the light source and the fixing member in the embodiment.

### DESCRIPTION OF EXEMPLARY EMBODIMENTS

An embodiment of the invention is explained below with reference to the diagrams.

### Exterior Configuration of a Projector

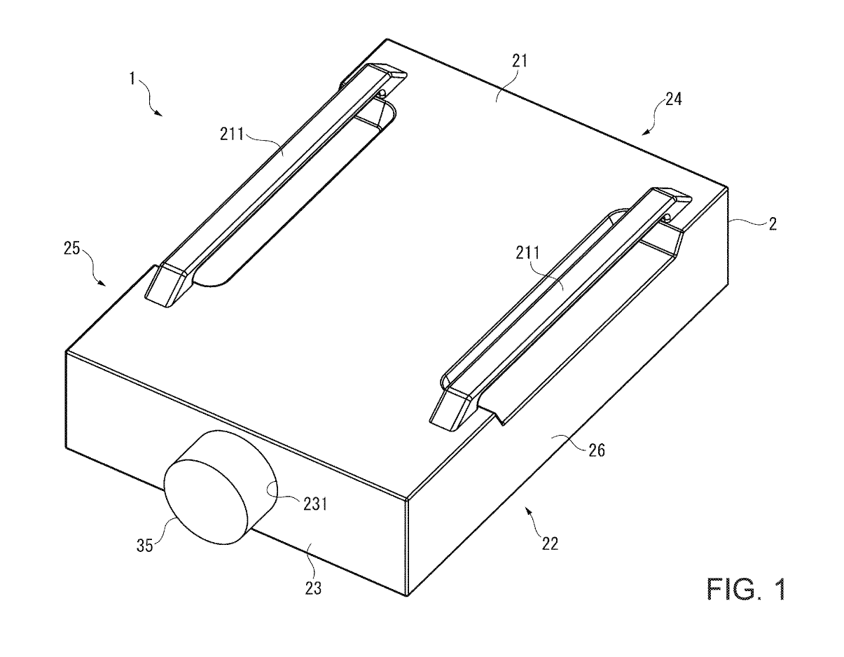

FIG. 1 is a schematic perspective view showing a projector 1 according to this embodiment.

The projector 1 according to this embodiment is a projection-type display apparatus that modulates light emitted from an illumination device 31 explained below, forms an image corresponding to image information, and enlarges and projects the image on a projection surface such as a screen. As shown in FIG. 1, the projector 1 includes an exterior housing 2 that configures an exterior.

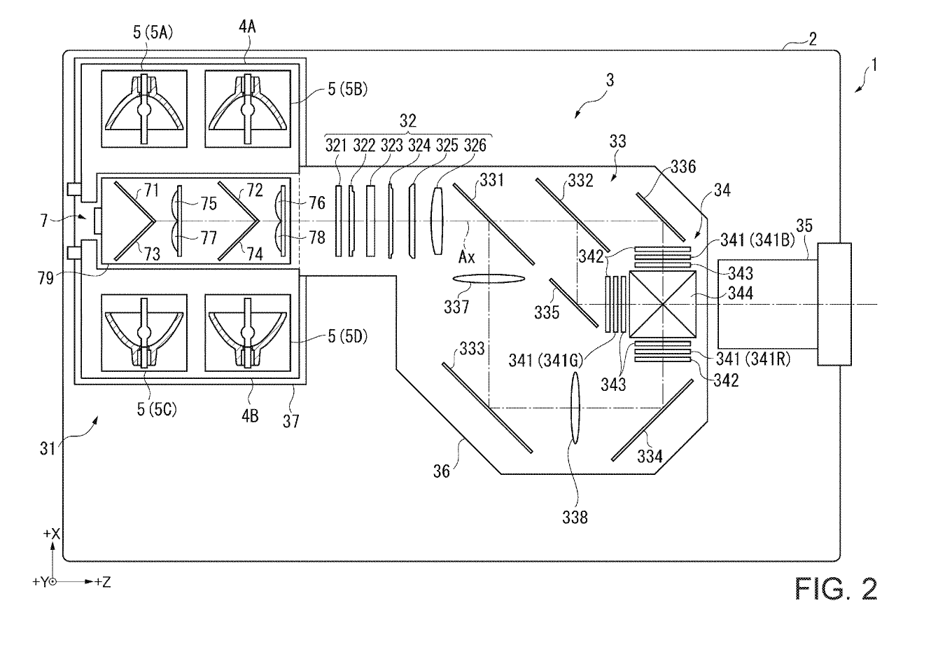

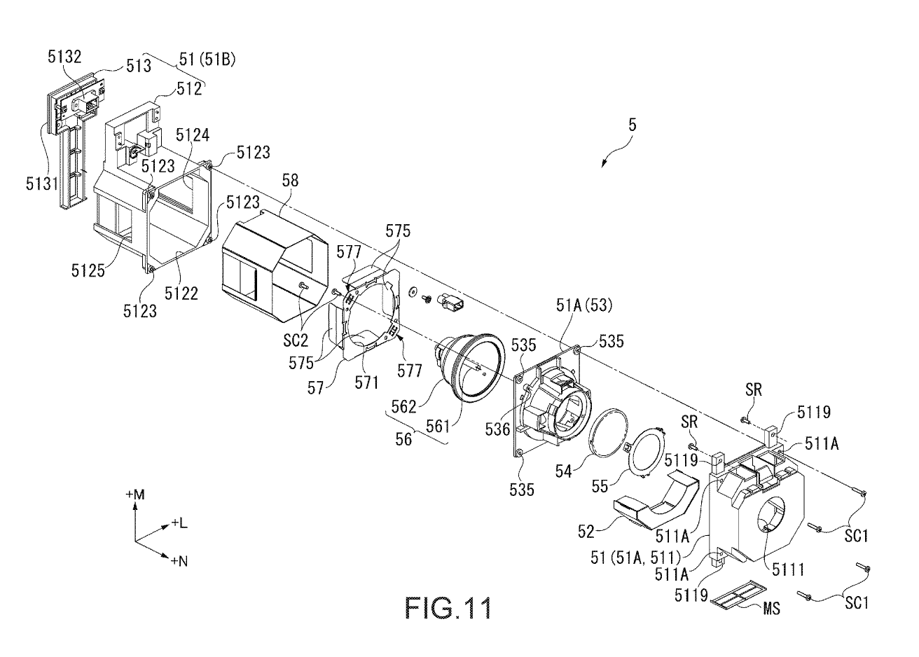

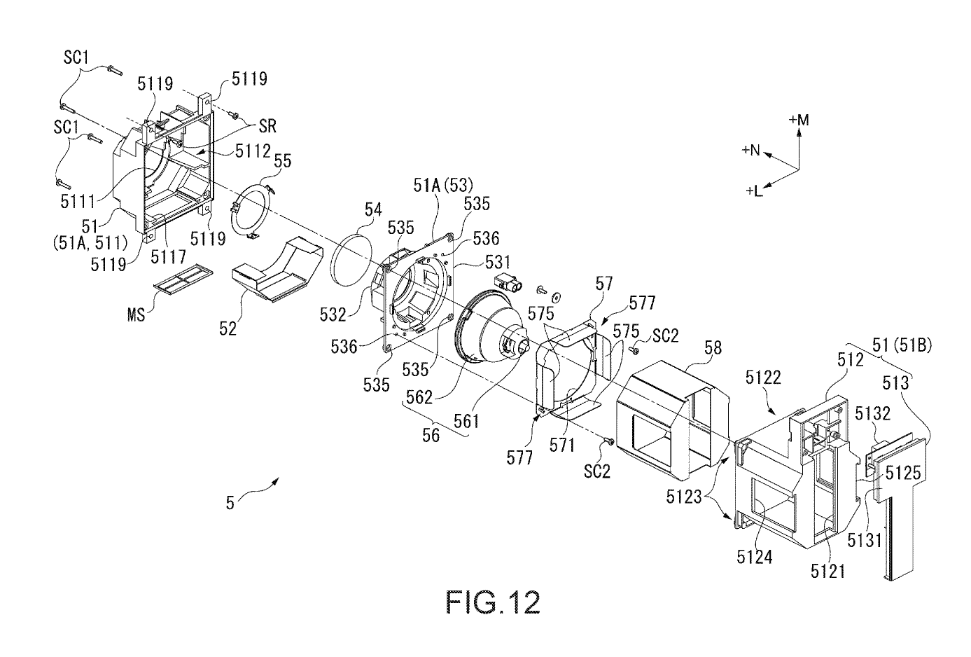

As explained in detail below, such a projector 1 includes, in the exterior housing 2, the illumination device 31 (see FIG. 2) including a plurality of lamp units 4 to which a plurality of light source devices 5 are detachably attached and an optical-path changing device 7 that aligns lights emitted from the lamp units in one direction and emits the lights. As one characteristic of the projector 1, the projector 1 is configured such that a removing direction of fixtures for fixing the light source devices 5 to attaching sections of light-source attaching members 6 configuring the lamp units 4 and a removing direction of fixtures for fixing a first housing 511 and a second housing 512 (see FIGS. 11 and 12) configuring the light source device 5 are opposite. As another characteristic of the projector 1, a reflector 562 (see FIGS. 11 and 12), which is a round reflector, is adopted as the light source device 5 and the reflector 562 is fixed to an emission side housing 51A located on a light emission side.

The configuration of the projector 1 is explained below.

### Configuration of the Exterior Housing

The exterior housing 2 is formed in a substantially rectangular parallelepiped shape. The exterior housing 2 includes a top surface section 21, a bottom surface section 22, a front surface section 23, a rear surface section 24, a left side surface section 25, and a right side surface section 26.

In the top surface section 21, a pair of handle sections 211 used for, for example, gripping of the projector 1 by a user and fixing of the projector 1 to an instrument set on a ceiling or the like is provided.

In the bottom surface section 22, although not shown in the figure, a leg section, which comes into contact with a placing surface when the projector 1 is placed on the placing surface, is provided.

In the front surface section 23, an opening section 231 for exposing a part of a projection optical device 35 explained below is formed.

In the rear surface section 24, although not shown in the figure, an opening section for inserting and removing the lamp units 4 (4A and 4B) and the optical-path changing device 7 of the illumination device 31 explained below (see FIG. 2) into and from the exterior housing 2 is formed. The opening section is covered by a cover member.

### Internal Configuration of the Projector

FIG. 2 is a schematic diagram showing the internal configuration of the projector 1.

The projector 1 includes, besides the exterior housing 2, as shown in FIG. 2, an image forming device 3 disposed in the exterior housing 2. Besides, the projector 1 includes a control device that controls the projector 1 and a power supply device that supplies electric power to electronic components configuring the projector 1.

### Configuration of an Image Forming Device

The image forming device 3 forms and projects an image corresponding to image information input from the control device. The image forming device 3 includes the illumination device 31, an equalizing device 32, a color separating device 33, an electro-optical device 34, a projection optical device 35, a housing for optical components 36, and a base member 37.

Among these components, the base member 37 is a member that is connected to the housing for optical components 36 and to which the lamp units 4 (4A and 4B) and the optical-path changing device 7 configuring the illumination device 31 are fixed.

The illumination device 31 emits light to the equalizing device 32. The configuration of the illumination device 31 is explained below in detail.

The equalizing device 32 equalizes the illuminance in a surface orthogonal to the center axis of the light emitted from the illumination device 31. The equalizing device 32 includes a cinema filter 321, a first lens array 322, a UV filter 323, a second lens array 324, a polarization converting element 325, and an superimposing lens 326.

The color separating device 33 separates the light made incident from the equalizing device 32 into three color lights of red (R), green (G), and blue (B). The color separating device 33 includes dichroic mirrors 331 and 332, reflecting mirrors 333 to 336, and relay lenses 337 and 338.

The electro-optical device 34 modulates the separated color lights according to the image information and thereafter combines the modulated color lights. The electro-optical device 34 includes liquid crystal panels 341 (liquid crystal panels for red, green, and blue are respectively represented as 341R, 341G, and 341B) functioning as light modulating devices provided for the respective separated color lights, an incidence-side sheet polarizer 342 and an emission-side sheet polarizer 343, and one color combining device 344. Among these components, as the color combining device 344, a cross dichroic prism can be adopted.

The projection optical device 35 is a projection lens that enlarges and projects, on the projection surface, light (light for forming an image) combined by the color combining device 344. As such a projection optical device 35, an assembled lens in which a plurality of lenses are disposed in a lens barrel can be adopted.

The housing for optical components 36 is a box-like housing in which an illumination optical axis Ax is set on the inside. The equalizing device 32 and the color separating device 33 are disposed in positions on the illumination optical axis Ax in the housing for optical components 36. The illumination device 31, the electro-optical device 34, and the projection optical device 35 are located outside the housing for optical components 36 but are disposed according to the illumination optical axis Ax.

### Configuration of the Illumination Device

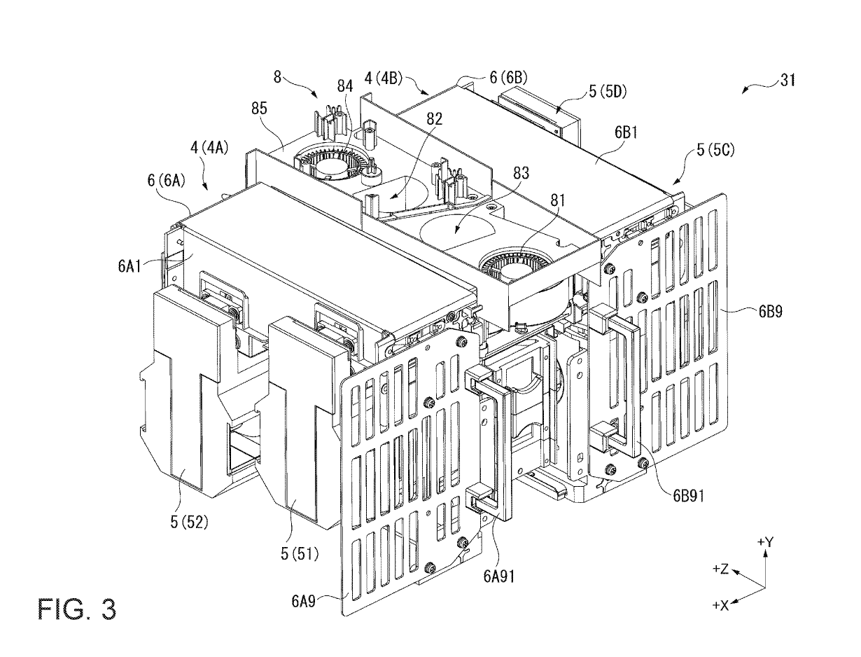

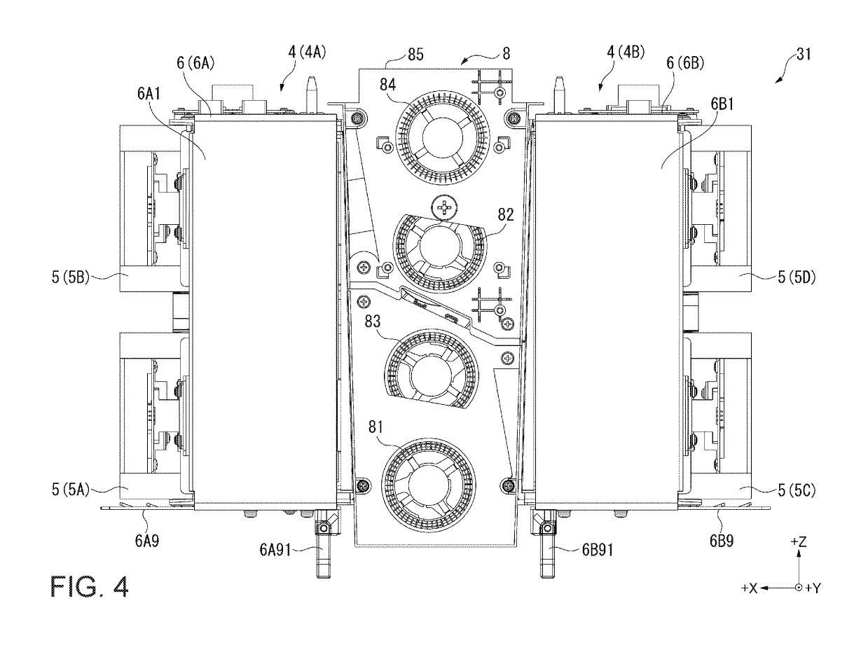

FIG. 3 is a perspective view showing the illumination device 31. FIG. 4 is a plan view showing the illumination device 31.

The illumination device 31 emits light to the equalizing device 32 as explained above. The illumination device 31 includes, as shown in FIGS. 2 to 4, the plurality of lamp units 4 (4A and 4B), each including a plurality of light source devices 5, the optical-path changing device 7, and a cooling device 8. Specifically, the illumination device 31 includes two lamp units 4A and 4B, each including two light source devices 5, the optical-path changing device 7, and the cooling device 8.

Note that, in the following explanation, a traveling direction of light emitted from the illumination device 31 is referred to as +Z direction and directions respectively orthogonal to the +Z direction and orthogonal to each other are referred to as +X direction and +Y direction. In this embodiment, a direction from the left side surface section 25 toward the right side surface section 26 is set as the +X direction. A direction from the bottom surface section 22 toward the top surface section 21 is set as the +Y direction. Although not shown in the figure, for convenience of explanation, the opposite direction of the +Z direction is set as a −Z direction in the following explanation. The same applies to a −X direction and a −Y direction.

### Configuration of the Cooling Device

Under the control by the control device, the cooling device 8 feeds a cooling gas supplied to the light source devices 5 and cools luminous tubes 561 (see FIG. 11) configuring the light source devices 5. As shown in FIGS. 3 and 4, the cooling device 8 is disposed on the Y-direction side with respect to the optical-path changing device 7. Such a cooling device 8 includes cooling fans 81 to 84 respectively independently driven to suck the cooling gas in the exterior housing 2 and feed the cooling gas supplied to the light source devices 5 corresponding to the cooling fans 81 to 84 and a box-like housing 85 in which the cooling fans 81 to 84 are disposed.

Note that, as explained in detail below, the cooling gas fed from the cooling fans 81 and 82 along the −X direction is supplied to light source devices 5A and 5B via two flow diverting members DM respectively corresponding to the light source devices 5A and 5B. The cooling gas fed from the cooling fans 83 and 84 along the +X direction is supplied to light source devices 5C and 5D via two flow diverting members DM respectively corresponding to the light source devices 5C and 5D.

### Configuration of the Lamp Units

Each of the lamp units 4A and 4B includes the two light source devices 5 and the light-source attaching member 6 to which the two light source devices 5 are attached. Specifically, of the lamp units 4A and 4B, a first lamp unit 4A includes the light source devices 5A and 5B and a light-source attaching member 6A and a second lamp unit 4B includes the light source devices 5C and 5D and a light-source attaching member 6B.

Among these components, the configuration of the light source device 5 is explained in detail below.

The light-source attaching member 6 (6A, 6B) is inserted into and removed from the projector 1 in a state in which the two light source devices 5 are attached.

### Configuration of the Light-Source Attaching Member

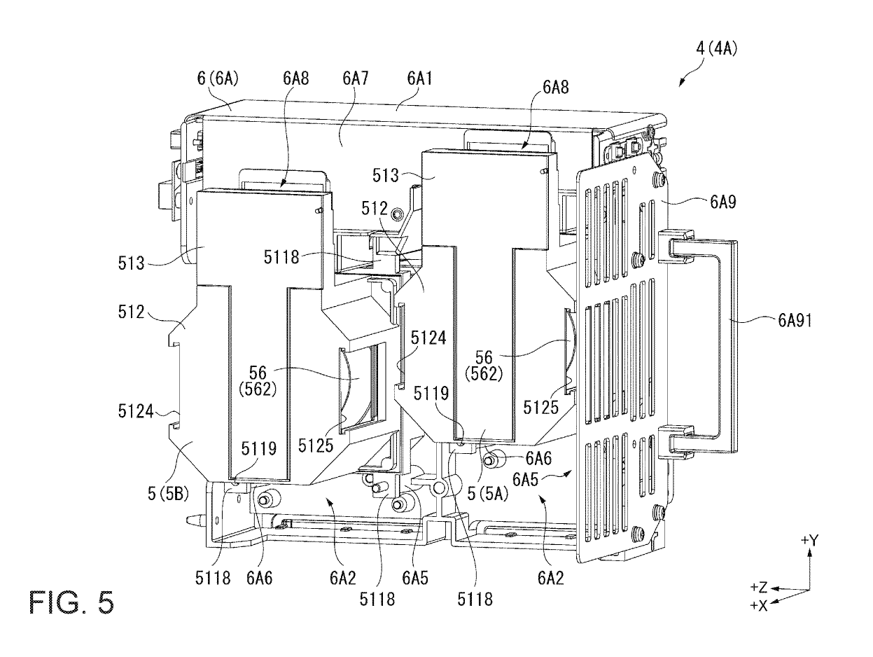

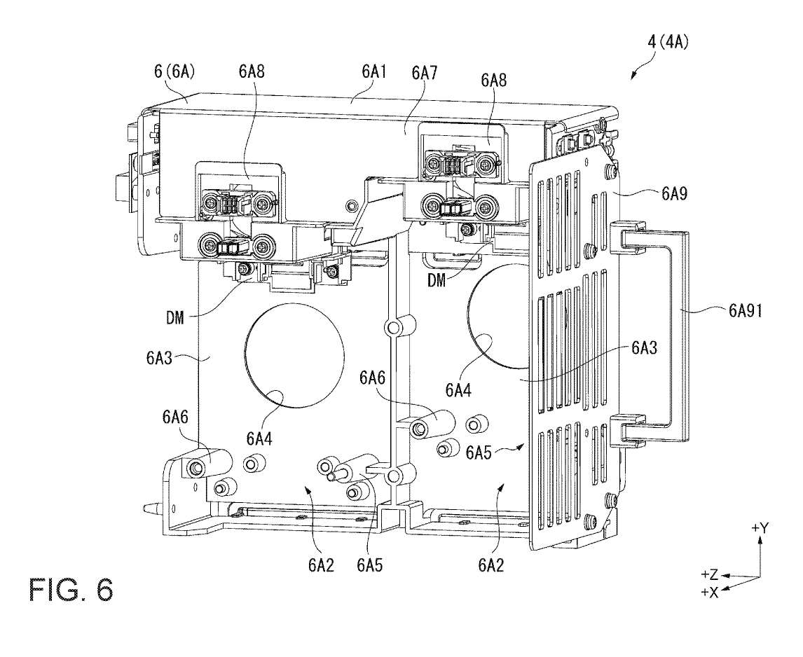

FIG. 5 is a perspective view showing the first lamp unit 4A. FIG. 6 is a perspective view showing the light-source attaching member 6A. That is, FIGS. 5 and 6 are perspective views of the light-source attaching member 6A attached with the light source devices 5A and 5B and the light-source attaching member 6A not attached with the light source devices 5 respectively viewed from the same direction.

The light-source attaching member 6A configuring the first lamp unit 4A includes, as shown in FIGS. 5 and 6, a main body section 6A1 including two attaching sections 6A2 arranged in series in the Z direction and a gripping section 6A9 fixed to the main body section 6A1.

The gripping section 6A9 is fixed to the end portion on the −Z-direction side in the main body section 6A1. In the gripping section 6A9, a handle 6A91 gripped by the user is provided to be capable of turning about an axis extending along the +Y direction.

In the two attaching sections 6A2, the light source devices 5 are attached along the −X direction with surfaces on the light emission side opposed to each other. The light source device 5A is attached to the attaching section 6A2 on the −Z-direction side and the light source device 5B is attached to the attaching section 6A2 on the +Z-direction side of the attaching sections 6A2.

The attaching sections 6A2 respectively include side surface sections 6A3 opposed to the surfaces on the light emission side in the light source devices 5 as shown in FIG. 6. In the side surface sections 6A3, opening sections 6A4 having a substantially circular shape, through which lights emitted from the light source devices 5 corresponding the side surface sections 6A3 pass, are formed. That is, the surfaces on the light emission side in the light source devices 5 are covered by the side surface sections 6A3 (the light-source attaching members 6A).

Besides, the side surface section 6A3 includes a plurality of bosses 6A5 and 6A6 projecting to the light source device 5 side. At the distal end of the boss 6A5, a positioning protrusion inserted into the light source device 5 to position the light source device 5 is provided. In the boss 6A6, a screw hole in which a screw SR (see FIGS. 11 and 12) inserted into the light source device 5 is screwed is formed.

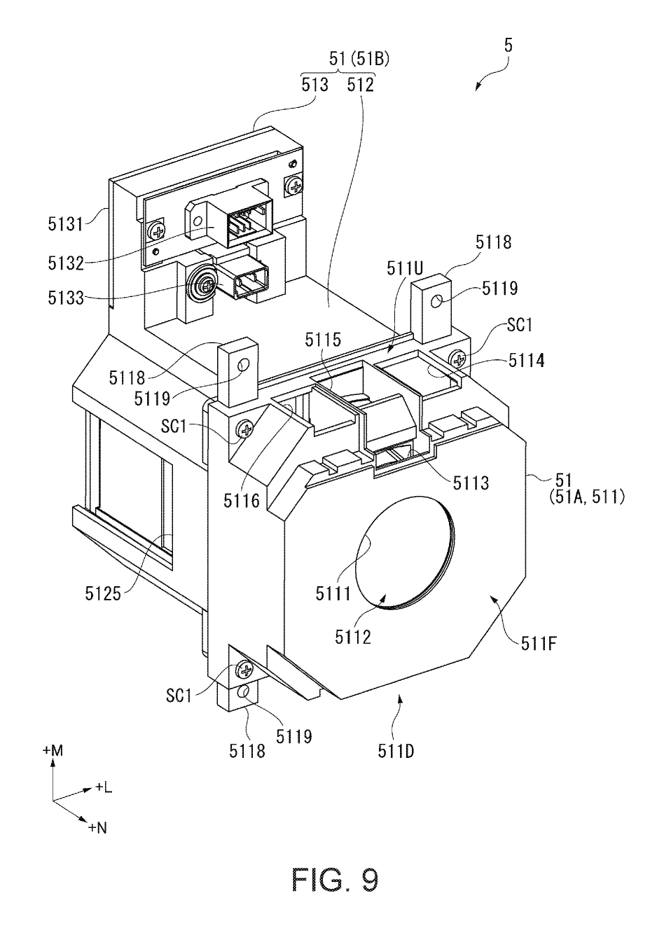

The attaching sections 6A2 include, in positions on the +Y-direction side, projecting sections 6A7 projecting to the +X-direction side (the light source device 5 side). In the projecting section 6A7, two terminals 6A8 connected to connectors 5132 and 5133 (see FIG. 9) provided in the light source device 5 to supply electric power to the light source device 5 are provided to correspond to the respective attaching sections 6A2.

When the light source device 5 is attached to the attaching section 6A2, first, a surface 511F (see FIG. 9) on the light emission side of the light source device 5 is directed to the attaching section 6A2. The light source device 5 is attached to the attaching section 6A2 such that the connectors 5132 and 5133 and the terminal 6A8 are connected. When the light source device 5 is attached to the attaching section 6A2, in a state in which the positioning protrusion of the boss 6A5 is inserted to position the light source device 5, the screw SR inserted through the light source device 5 is screwed in the screw hole of the boss 6A6. Consequently, as shown in FIG. 5, the light source device 5 is fixed to the attaching section 6A2 corresponding to the light source device 5. That is, the light source device 5 is attached to the attaching section 6A2 along a traveling direction of the emitted light of the light source device 5 (a +N direction explained below).

Note that, in the attaching section 6A2 located on the −Z-direction side and the attaching section 6A2 located on the +Z-direction side, positions in the +Y direction are different. Specifically, the attaching section 6A2 located on the −Z-direction side is located further on the +Y-direction side than the attaching section 6A2 located on the +Z-direction side. Therefore, of the light source devices 5A and 5B attached to the attaching sections 6A2, the light source device 5A is disposed further on the +Y-direction side than the light source device 5B.

The light-source attaching member 6B of the second lamp unit 4B includes, as shown in FIGS. 3 and 4, a main body section 6B1 same as the main body section 6A1 of the light-source attaching member 6A and a gripping section 6B9 same as the gripping section 6A9.

Of the main body section 6B1 and the gripping section 6B9, the gripping section 6B9 including a handle 6B91 is fixed to the end portion on the −Z-direction side in the main body section 6B1. That is, when the lamp units 4A and 4B are disposed to sandwich the optical-path changing device 7, the gripping section 6A9 and 6B9 are respectively located on the −Z-direction side in the illumination device 31.

Although not shown in the figure, the main body section 6B1 includes two attaching sections that are disposed side by side in series in the +Z direction and to which the light source devices 5C and 5D are respectively attached. The two attaching sections have a configuration same as the configuration of the attaching section 6A2. In the main body section 6B1, the attaching section on the +Z-direction side is located further on the +Y-direction side than the attaching section on the −Z-direction side. Consequently, the light source device 5D is fixed to a position further on the +Y-direction side than the light source device 5C.

That is, when the illumination device 31 is viewed along the +X direction or the −X direction, the light source devices 5A and 5C attached to the light-source attaching members 6A and 6B are disposed to be opposed to each other in positions overlapping in the +Z direction such that traveling directions of emitted lights are opposite directions each other. Similarly, the light source devices 5B and 5D attached to the light-source attaching members 6A and 6B are disposed to be opposed to each other in positions overlapping in the +Z direction such that traveling directions of emitted lights are opposite directions each other.

On the other hand, disposition positions in the Y direction of the light source devices 5A and 5C are different from each other. Disposition positions in the Y direction of the light source devices 5B and 5D are different from each other. In other words, the light source devices 5A and 5D are present in the same position in the Y direction. The light source devices 5B and 5C are present in the same position in the Y direction.

Consequently, it is possible to suppress the emitted light of one of the light source devices 5A and 5C opposed to each other from being made incident on the other. It is possible to suppress the emitted light of one of the light source devices 5B and 5D opposed to each other from being made incident on the other.

### Configuration of the Flow Diverting Member

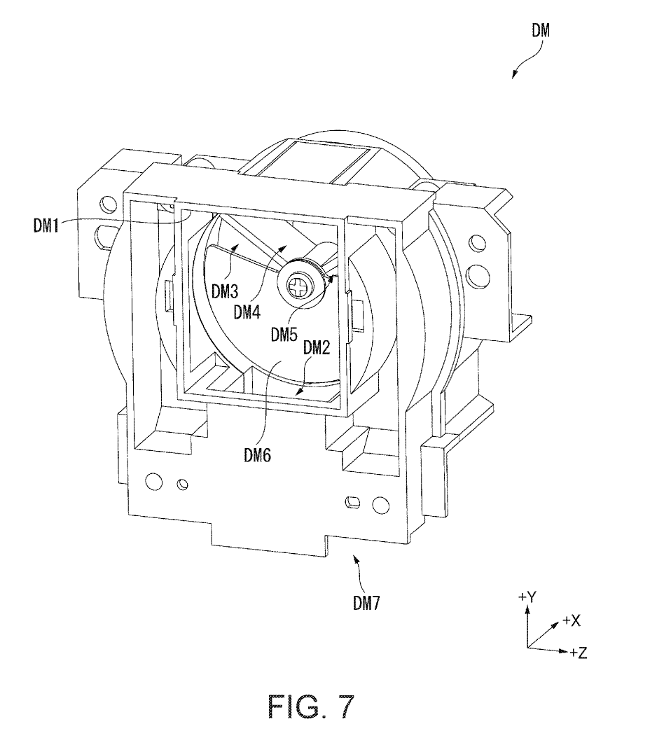

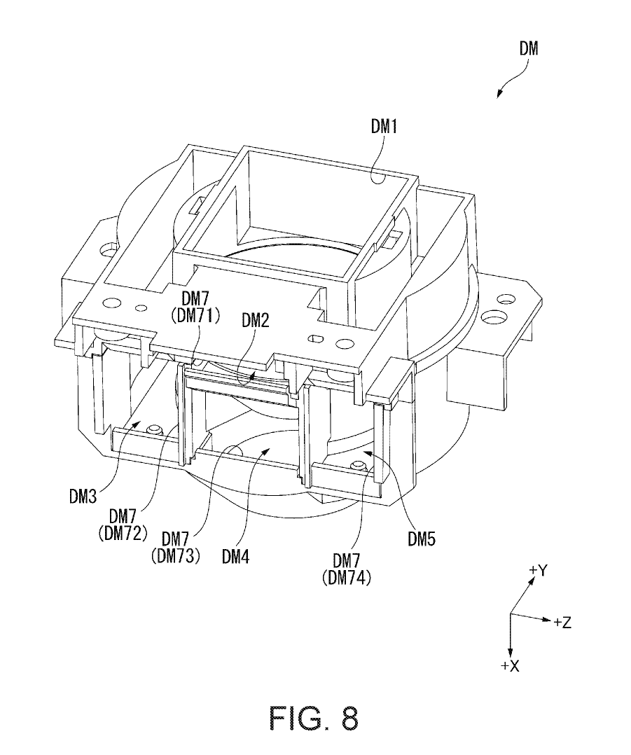

FIG. 7 is a perspective view of the flow diverting member DM viewed from an inflow side of a cooling gas. FIG. 8 is a perspective view of the flow diverting member DM viewed from the inflow side and a side opposed to the light source device 5.

In the projecting sections 6A7 in the main body sections 6A1 and 6B1, the flow diverting members DM, which guide the cooling gas fed from the cooling fans 81 to 84 to the light source devices 5 corresponding to the flow diverting members DM, are respectively provided. The flow diverting members DM include, as shown in FIGS. 7 and 8, a lead-in port DM1, a plurality of duct sections DM2 to DM5 independent from one another, a channel switching member DM6, and a lead-out port DM7.

The lead-in port DM1 is formed in a substantially square shape on a surface opposed to the cooling fan in the flow diverting member DM. One ends of the duct sections DM2 to DM5 communicate with the inside of the lead-in port DM1. In the lead-in port DM1, the channel switching member DM6, which is a tabular body having a substantially ⅗ circular shape is attached to be capable of rotating about a rotation axis extending along a circulating direction of the cooling gas to the lead-in port DM1. The channel switching member DM6 rotates with own weight thereof according to the posture of the projector 1 to thereby switch, among the duct sections DM3 to DM5, a duct section to which a part of the cooling gas led into the lead-in port DM1 mainly circulates.

Note that one end of the duct section DM2 is located further on an upstream side of the cooling gas than the channel switching member DM6 in the lead-in port DM1. Therefore, irrespective of the posture of the projector 1, that is, a rotating state of the channel switching member DM6, a part of the cooling gas led into the lead-in port DM1 is led into the duct section DM2.

The lead-out port DM7 is configured by lead-out ports DM71 to DM74 formed by the other ends of the duct sections DM2 to DM5. Among the lead-out ports DM71 to DM74, the lead-out port DM7 is formed by the other end of the duct section DM2. The lead-out port DM72 is formed by the other end of the duct section DM3. The lead-out port DM73 is formed by the other end of the duct section DM4. The lead-out port DM74 is formed by the other end of the duct section DM5.

Such a flow diverting member DM feeds the part of the cooling gas led into the lead-in port DM1 from the cooling fan corresponding to the light source device 5 in the cooling device 8 to the light source device 5 from the lead-out port DM71 via the duct section DM2. The flow diverting member DM feeds, via a duct section among the duct sections DM3 to DM5 not closed by the channel switching member DM6 rotated according to the posture of the projector 1, another part of the cooling gas led into the lead-in port DM1 to the light source device 5 from a lead-out port (at least any one of the lead-out ports DM72 to DM74) corresponding to the duct section.

Consequently, it is possible to blow the cooling gas from a position corresponding to the posture of the projector 1 to the luminous tube 561 of the light source device 5 explained below.

### Configuration of the Optical-Path Changing Device

The optical-path changing device 7 is disposed between the lamp units 4A and 4B as shown in FIG. 2. The optical-path changing device 7 reflects, to the +Z direction side, lights made incident from the light source devices 5A and 5B along the −X direction and lights made incident from the light source devices 5C and 5D along the +X direction and makes the lights incident on the equalizing device 32.

Such an optical-path changing device 7 includes the four reflecting mirrors 71 to 74 and the four lenses 75 to 78 provided to correspond to the light source devices 5A to 5D and a housing 79 in which the reflecting mirrors 71 to 74 and the lenses 75 to 78 are housed on the inside.

The reflecting mirror 71 is disposed in a position where the emitted light from the light source device 5A is made incident. The reflecting mirror 72 is disposed in a position where the emitted light from the light source device 5B is made incident. The reflecting mirror 73 is disposed in a position where the emitted light from the light source device 5C is made incident. The reflecting mirror 74 is disposed in a position where the emitted light from the light source device 5D is made incident. The reflecting mirrors 71 to 74 reflect the incident lights to the +Z-direction side.

Note that, as explained above, the light source devices 5A and 5D are located further on the +Y-direction side than the light source devices 5B and 5C. Therefore, the reflecting mirrors 71 and 74, on which the lights are made incident from the light source devices 5A and 5D, are also located further on the +Y-direction side than the reflecting mirrors 72 and 73, on which the lights are made incident from the light source devices 5B and 5C.

The lenses 75 to 78 are provided on optical paths of the lights reflected by the reflecting mirrors 71 to 74 corresponding to the lenses 75 to 78. Specifically, when viewed from the +Y-direction side, the lens 75 is disposed between the reflecting mirrors 71 and 72 and collimates the emitted light of the light source device 5A reflected by the reflecting mirror 71. The lens 76 is disposed on the +Z-direction side with respect to the reflecting mirror 72 and collimates the emitted light of the light source device 5B reflected by the reflecting mirror 72. Similarly, the lens 77 is disposed between the reflecting mirrors 73 and 74 and collimates the emitted light of the light source device 5C reflected by the reflecting mirror 73. The lens 78 is disposed on the +Z-direction side with respect to the reflecting mirror 74 and collimates the emitted light of the light source device 5D reflected by the reflecting mirror 74.

With such an optical-path changing device 7, the emitted lights of the light source devices 5A to 5D are reflected and collimated by the reflecting mirrors 71 to 74 and the lenses 75 to 78 and emitted to the +Z-direction side.

### Configuration of the Light Source Device

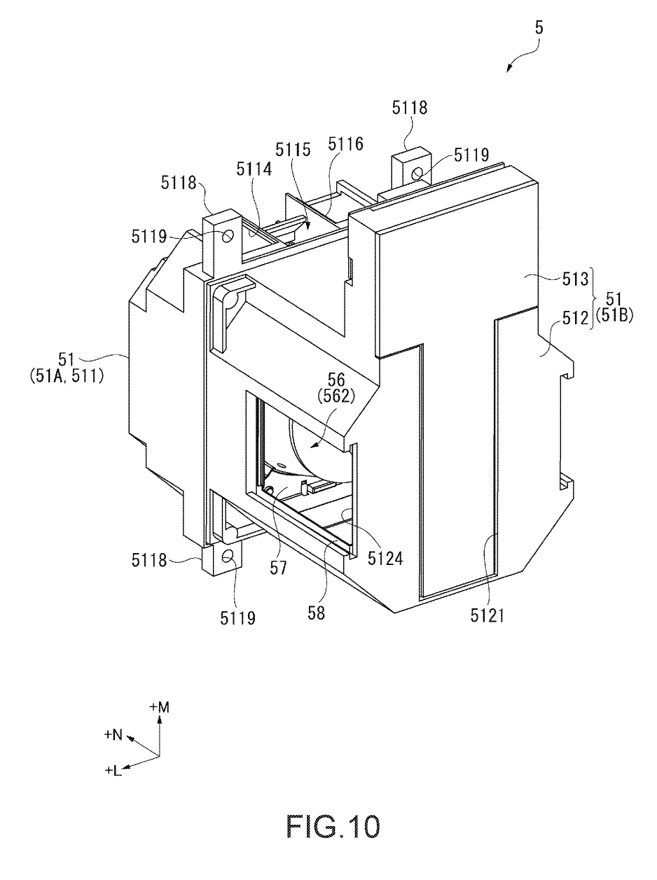

FIG. 9 is a perspective view of the light source device 5 viewed from the light emission side. FIG. 10 is a perspective view of the light source device 5 viewed from the opposite side of the light emission side. FIG. 11 is an exploded perspective view of the light source device 5 viewed from the light emission side. FIG. 12 is an exploded perspective view of the light source device 5 viewed from the opposite side of the light emission side.

As explained above, the light source devices 5 (5A to 5D) are attached to the light-source attaching members 6. The light source devices 5 respectively emit lights toward the optical-path changing device 7.

The light source devices 5 include, as shown in FIGS. 9 and 10, a housing 51 and further include, as shown in FIGS. 11 and 12, a light blocking member 52, an intermediate member 53, a collimating lens 54, a pressing member 55, a light source 56, a fixing member 57, a light blocking member 58, and a plurality of screws SC1 and SC2.

Note that, in the following explanation, a traveling direction of light emitted from the light source device 5 is referred to as +N direction and directions orthogonal to the +N direction and orthogonal to each other are referred to as +L direction and +M direction. In this embodiment, a direction extending along the +Y direction when the light source device 5 is attached to the light-source attaching member 6 is referred to as +M direction. A direction extending from the left to the right when the light source device 5 is viewed from the light emission side with the +M-direction side set on the upper side is referred to as +L direction. That is, in the light source devices 5A and 5B attached to the light-source attaching member 6A, the +N direction coincides with the −X direction, the +M direction coincides with the +Y direction, and the +L direction coincides with the +Z direction. On the other hand, in the light source devices 5C and 5D attached to the light-source attaching member 6B, the +N direction coincides with the +X direction, the +M direction coincides with the +Y direction, and the +L direction coincides with the −Z direction. Note that, although not shown in the figure, for convenience of explanation, the opposite direction of the +N direction is set as a −N direction in the following explanation. The same applies to a −M direction and a −L direction.

### Configuration of the Housing

The housing 51 is a housing for a light source that houses the members 52 to 58 on the inside. The housing 51 is configured by combining the first housing 511, the second housing 512 and a terminal section 513, and the intermediate member 53 explained below. That is, the first housing 511 and the intermediate member 53 are combined, whereby the emission side housing 51A located on the light emission side from the light source device 5 in the housing 51 is configured. The second housing 512 and the terminal section 513 are combined, whereby a proximal-end side housing 51B located on the opposite side of the light emission side in the housing 51 is configured.

### Configurations of the Second Housing and the Terminal Section

The second housing 512 and the terminal section 513 are explained first.

As explained above, the second housing 512 and the terminal section 513 are combined with each other to configure the proximal-end side housing 51B located on the light-emitting-direction proximal end side (the −N-direction side) in the housing 51.

Of the second housing 512 and the terminal section 513, as shown in FIGS. 9 to 12, the terminal section 513 is formed in a substantial T-shape in which a wide section 5131 wide in the +L direction is formed on the +M-direction side. In the wide section 5131, two connectors 5132 and 5133 that supply electric power to the luminous tubes 561 explained below are provided. The connectors 5132 and 5133 are connected to terminal sections (e.g., the terminals 6A8) provided in the light-source attaching members 6.

The second housing 512 is a box-like housing having a substantially rectangular parallelepiped shape and is fixed with the terminal section 513 fit in a concave section 5121 formed on the end face on the −N-direction side. The end portion on the −N-direction side in the second housing 512 projects to the +M-direction side. The terminal section 513 is attached to the second housing 512 such that the projecting portion and the wide section 5131 overlap.

Such a second housing 512 includes an opening section 5122 having a substantially octagonal shape opened on the +N-direction side. In the opening section 5122, the end portion on the −N-direction side in the reflector 562 configuring the light source 56 and the light blocking member 58 formed in a hollow substantially octagonal prism shape are housed.

Note that the light blocking member 58 is a metal member that suppresses the inside of the second housing 512 from being deteriorated by an ultraviolet ray and an infrared ray transmitted through the reflector 562 in the light emitted from the luminous tube 561.

Screw holes 5123 are formed at four corners of the end face on the +N-direction side in the second housing 512, that is, around the opening section 5122. The screws SC1 inserted through the first housing 511 are screwed in the screw holes 5123. Consequently, the second housing 512 and the first housing 511 are combined and the housing 51 is configured.

Note that circulation ports 5124 and 5125 for the cooling gas are respectively formed on the side surface on the +L-direction side and the side surface on the −L-direction side in the second housing 512. The cooling gas passing through the circulation ports 5124 and 5125 passes through circulation ports respectively formed on the side surface on the +L-direction side and the side surface on the −L-direction side in the light blocking member 58 and cools the end face on the −N-direction side of the reflector 562 in a process of the circulation.

### Configuration of the First Housing

The first housing 511 is located at the end in the +N direction in the light source device 5, combined with the intermediate member 53 explained below to configure the emission side housing 51A, and fixed to the second housing 512 by the screws SC1 from the +N-direction side. That is, when the light source device 5 is attached to the light-source attaching member 6, the first housing 511 is located on the light-source attaching member 6 side (the +N-direction side) with respect to the second housing 512. The second housing 512 is located on the opposite side of the light-source attaching member 6 (the −N-direction side). The first housing 511 is equivalent to the main body section in the emission side housing 51A.

On the surface 511F on the +N-direction side in such a first housing 511, as shown in FIG. 12, an opening section 5111 having a substantially circular shape, through which light emitted from the light source 56 housed in the housing 51 passes, is formed. The surface 511F (the surface 511F on the light emission side) is apart opposed to the attaching section (e.g., the attaching section 6A2) and covered by the attaching section when the light source device 5 is attached to the light-source attaching member 6.

The first housing 511 includes a concave housing section 5112 opened on the −N-direction side. The light blocking member 52 explained below is disposed in the housing section 5112. The intermediate member 53 is attached to close the housing section 5112 from the −N-direction side.

On a surface 511U on the +M-direction side in the first housing 511, lead-in ports 5113 to 5116 for leading the cooling gas fed from the flow diverting member DM into the inside are formed to correspond to the lead-out ports DM71 to DM74. The cooling gas led into the first housing 511 via the lead-in ports 5113 to 5116 is supplied to the light source 56 via the intermediate member 53.

On a surface 511D on the −M-direction side in the first housing 511, a discharge port 5117 (see FIG. 12) for discharging the cooling gas, which has cooled the light source 56, is formed. The discharge port 5117 is covered by a mesh MS. The mesh MS suppresses, when the luminous tube 561 is ruptured, broken pieces from scattering from the discharge port 5117.

Projecting sections 5118 are protrudingly provided near both the ends in the +L direction of the surface 511U and near both the ends in the +L direction of the surface 511D. Specifically, the projecting sections 5118 located on the surface 511U project to the +M-direction side. The projecting sections 5118 located on the surface 511D project to the −M-direction side.

As shown in FIG. 5, the projecting sections 5118 are located further on the outer side than the second housing 512 when viewed from the −N-direction side (the +X-direction side in the example shown in FIG. 5). The projecting sections 5118 are accessible from the −N-direction side without being covered by the second housing 512.

Hole sections 5119 are formed in the respective projecting sections 5118. The positioning protrusions of the bosses 6A5 are inserted into the two hole sections 5119 among the four hole sections 5119. The screws SR (see FIGS. 11 and 12) are inserted through the other two hole sections 5119 from the −N-direction side along the +N direction.

Note that insertion holes 511A, into which the screws SC1 are inserted from the +N-direction side along the −N direction, are respectively formed at the corner sections on the surface 511F and in positions further on the center side of the first housing 511 than the projecting sections 5118.

### Configuration of the Light Blocking Member

As explained above, the light blocking member 52 is inserted into the housing section 5112 from the −N-direction side. The intermediate member 53 closes the housing section 5112 from the −N-direction side.

The light blocking member 52 has a function of protecting the first housing 511 from light passing through two openings provided across an opening section 5345 in the light emitted from the luminous tube 561 on the side surface of an air guide section 532 of the intermediate member 53 explained below.

### Configuration of the Intermediate Member

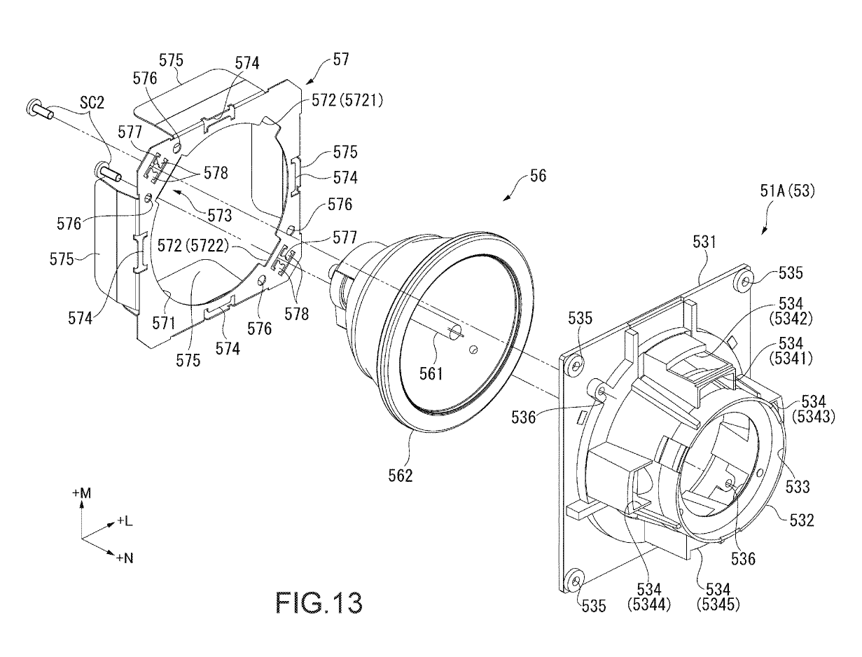

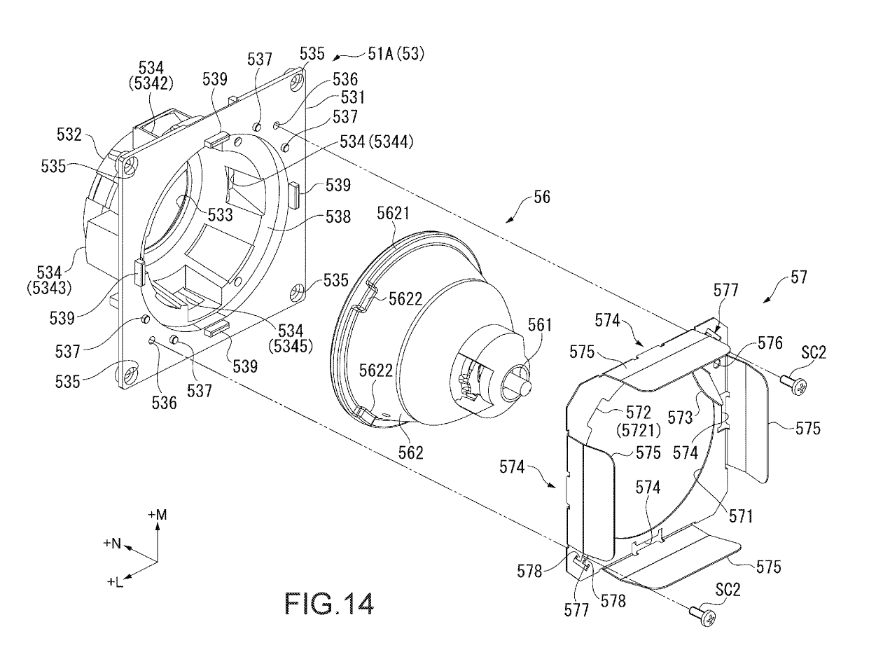

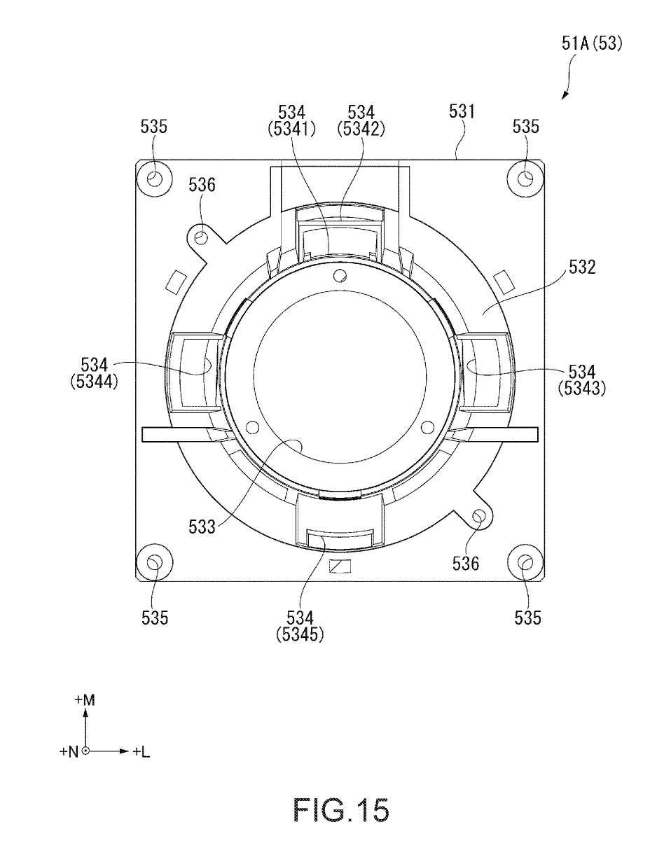

FIGS. 13 and 14 are exploded perspective views of the intermediate member 53, the light source 56, and the fixing member 57 viewed from the light emission side (+N-direction side) and the opposite side of the light emission side (the −N-direction side). FIG. 15 is a diagram of the intermediate member 53 viewed from the +N-direction side.

The intermediate member 53 closes the housing section 5112 and configures the emission side housing 51A in a state in which the light source 56 and the fixing member 57 explained below are attached to the intermediate member 53. As shown in FIGS. 13 to 15, the intermediate member 53 is an integrally molded product including a main body section 531 having a substantially square shape when viewed from the +N-direction side and an air guide section 532, which is the substantial center of the main body section 531 projecting in a truncated cone shape in the +N direction.

When the intermediate member 53 is attached to the first housing 511, the air guide section 532 is disposed in the housing section 5112. The air guide section 532 has a function of guiding the cooling gas led into the first housing 511 to the luminous tube 561 (see FIG. 11) located on the inner side of the air guide section 532.

As shown in FIGS. 13 and 15, an opening section 533 having a substantially circular shape is formed on the +N-direction side in the air guide section 532. As shown in FIGS. 11 and 12, the collimating lens 54 is fit in the opening section 533. The pressing member 55, which presses the collimating lens 54, is fixed to the end edge of the opening section 533.

As shown in FIGS. 13 and 15, five opening sections 534 (5341 to 5345) are formed on the side surface of the air guide section 532.

The opening section 5341 is located on the +M-direction side on the side surface of the air guide section 532. The opening section 5341 causes the cooling gas, which is led in from the lead-in port 5113, to flow into the air guide section 532 from the +M-direction side.

The opening section 5342 is located on the −N-direction side with respect to the opening section 5341. The opening section 5342 causes the cooling gas, which is led in from the lead-in port 5115, to flow into the air guide section 532 from the +M-direction side.

The opening section 5343 is located on the +L-direction side on the side surface of the air guide section 532. The opening section 5343 causes the cooling gas, which is led in from the lead-in port 5114 via a duct section (not shown in the figures) formed by combining the air guide section 532 and the first housing 511, to flow into the air guide section 532 from the +L-direction side.

The opening section 5344 is located on the −L-direction side on the side surface of the air guide section 532. The opening section 5344 causes the cooling gas, which is led in from the lead-in port 5116 via another duct section (not shown in the figures) formed by combining the air guide section 532 and the light blocking member 52, to flow into the air guide section 532 from the −L-direction side.

The opening section 5345 is located on the −M-direction side on the side surface of the air guide section 532.

The cooling gas, which has passed through the opening sections 5342 to 5344 among the opening sections 5341 to 5345, is fed to a light emitting section 5611 of the luminous tube 561 explained below. On the other hand, the cooling gas, which has passed through the opening section 5341, is fed to a sealing section 5613 of the luminous tube 561.

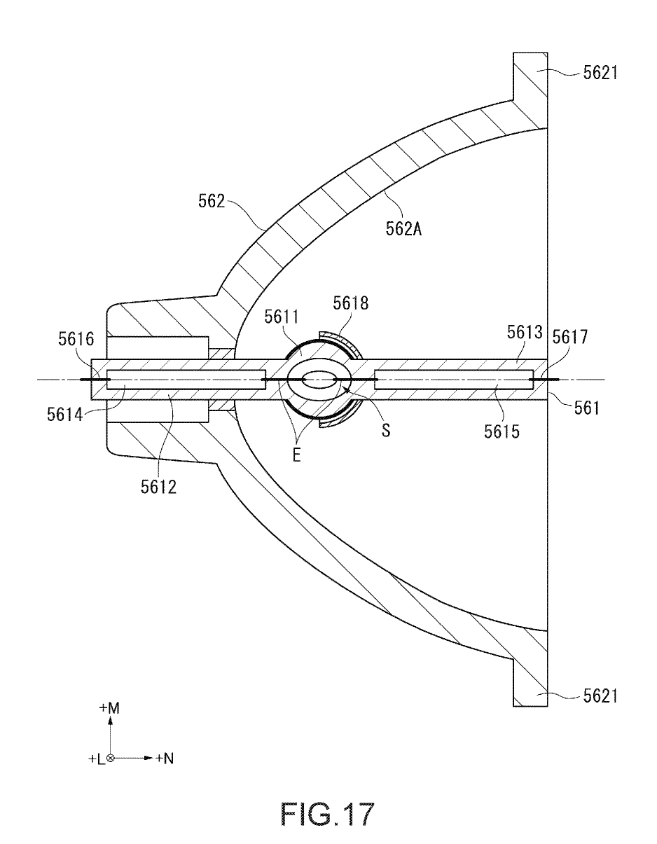

Consequently, according to the posture of the projector 1, it is possible to feed the cooling gas to an upper part (see FIG. 17) of the light emitting section 5611, where temperature is the highest among parts of the luminous tube 561, from at least any one of the opening sections 5342 to 5344. Besides, it is possible to feed the cooling gas to the sealing section 5613 irrespective of the posture of the projector 1. Therefore, it is possible to efficiently cool the light emitting section 5611. Besides, it is possible to surely cool a connecting section of an electrode drawing wire 5617 of the sealing section 5613 and a lead wire (not shown in the figures). The cooling gas, which has cooled the luminous tube 561 in this way, is fed in the −M direction via the opening section 5345 functioning as an outflow port, the intermediate member 53, and the first housing 511.

Hole sections 535, through which the screws SC1 (see FIGS. 11 and 12) inserted into the insertion holes 511A from the +N-direction side along the −N direction and screwed in the second housing 512 are inserted, are formed at the respective four corner sections in the main body section 531.

Screw holes 536, in which the screws SC2 for fixing the fixing member 57 explained below to the intermediate member 53 are screwed, are formed on one diagonal line in the main body section 531 and between one corner section and the air guide section 532 and between a corner section on the opposite side of the corner section and the air guide section 532. Further, positioning sections 537 (FIG. 14), which positions the fixing member 57 explained below, are protrudingly provided in the −N-direction side in positions across the respective screw holes 536.

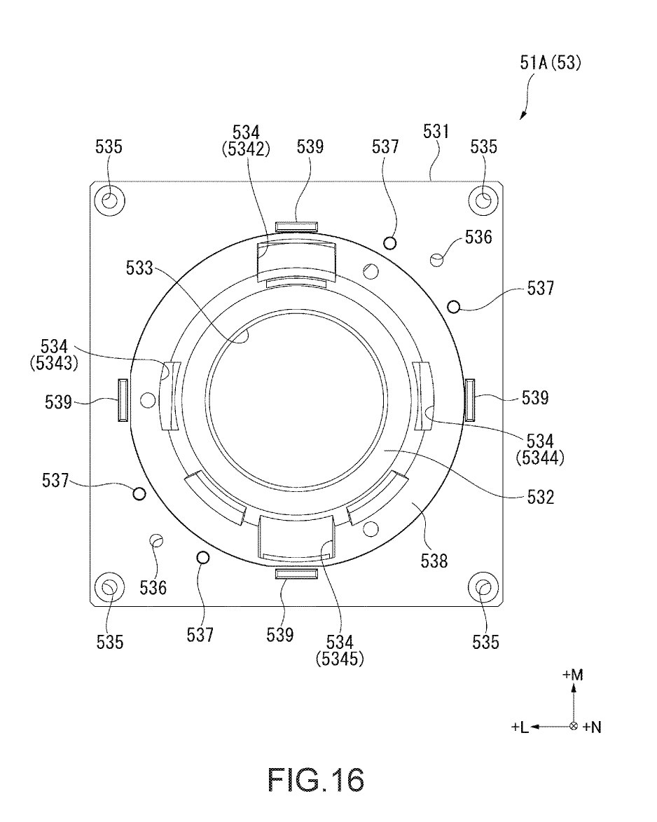

FIG. 16 is a diagram of the intermediate member 53 viewed from the −N-direction side.

As shown in FIGS. 14 and 16, an annular step section 538 recessed to the inner side is formed in a proximal end portion of the air guide section 532 when the intermediate member 53 is viewed from the −N-direction side. An opening end edge of the reflector 562 configuring the light source 56 is fit in the step section 538.

Four projecting sections 539 formed in a substantially rectangular shape are protrudingly provided at equal intervals around the air guide section 532 on the surface on the −N-direction side of the main body section 531. Specifically, the projecting sections 539 are formed in positions on the ±M-direction side and the ±L-direction side with respect to the air guide section 532. The projecting sections 539 are portions inserted into opening sections 574 of the fixing member 57 when the fixing member 57 explained below is attached to the intermediate member 53.

### Configuration of the Light Source

The light source 56 emits light to the +N-direction side. The light source 56 is pressed and fixed to the intermediate member 53 side by the fixing member 57 explained below. The light source 56 includes, as shown in FIGS. 13 and 14, the luminous tube 561 and the reflector 562.

### Configuration of the Luminous Tube

FIG. 17 is a diagram showing a cross section taken along an NM plane of the light source 56.

The luminous tube 561 is a light source lamp lit by electric power supplied from the outside. The luminous tube 561 includes, as shown in FIG. 17, a light emitting section 5611 bulging in a substantially spherical shape and a pair of sealing sections 5612 and 5613 extending from both the ends of the light emitting section 5611 in directions apart from each other.

On the inside of the light emitting section 5611, a discharge space S, in which a pair of electrodes E formed of tungsten is disposed, is formed. A luminescent substance is sealed in the discharge space S. A portion on the +N-direction side (the opposite side of the reflector 562) in the light emitting section 5611 is covered by a sub-reflecting mirror 5618 that reflects the light, which is emitted from the light emitting section 5611 on the +N-direction side, to the side of the reflector 562 functioning as a main reflecting mirror.

The sealing sections 5612 and 5613 are sealed in a state in which metal foils 5614 and 5615 respectively electrically connected to the electrode E are inserted into the insides of the sealing sections 5612 and 5613. Electrode draw-out wires 5616 and 5617 extending to the outside of the luminous tube 561 are respectively connected to the metal foils 5614 and 5615. When electric power is supplied to the electrode drawing wires 5616 and 5617 via lead wires (not shown in the figure), the inside of the light emitting section 5611 emits light.

### Configuration of the Reflector

The reflector 562 is a cold mirror that reflects visible light in lights made incident from the light emitting section 5611 and the sub-reflecting mirror 5618 to the +N-direction side and transmits an infrared ray and an ultraviolet ray in the light. The reflector 562 includes a reflection surface 562A having a concave curved surface shape. The reflector 562 is a circular reflector, the opening end edge of which is formed in a substantially circular shape when viewed from the +N-direction side and the end portion on the −N-direction side of which is formed in a substantially semispherical shape. As shown in FIG. 17, such a reflector 562 is fixed to the sealing section 5612 located on the −N-direction side with respect to the light-emitting section 5611 by an adhesive.

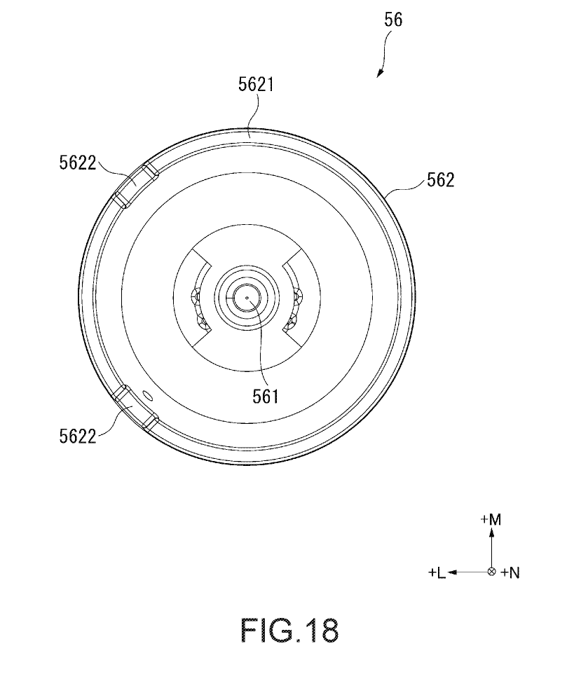

FIG. 18 is a diagram of the reflector 562 viewed from the −N-direction side.

At the opening end edge of the reflector 562, an annular section 5621 projecting to the outer side in a flange shape is formed. As shown in FIG. 18, the annular section 5621 is a portion formed in a substantially circular shape when viewed from the −N-direction side, fit in the step section 538 of the intermediate member 53, and pressed by the fixing member 57 explained below.

Two convex sections 5622 projecting to the −N-direction side are formed on the surface on the −N-direction side in the annular section 5621. Specifically, when the reflector 562 is viewed from the −N-direction side, the two convex sections 5622 are respectively provided in positions 90° apart from each other centering on a disposition position of the luminous tube 561.

### Configuration of the Fixing Member

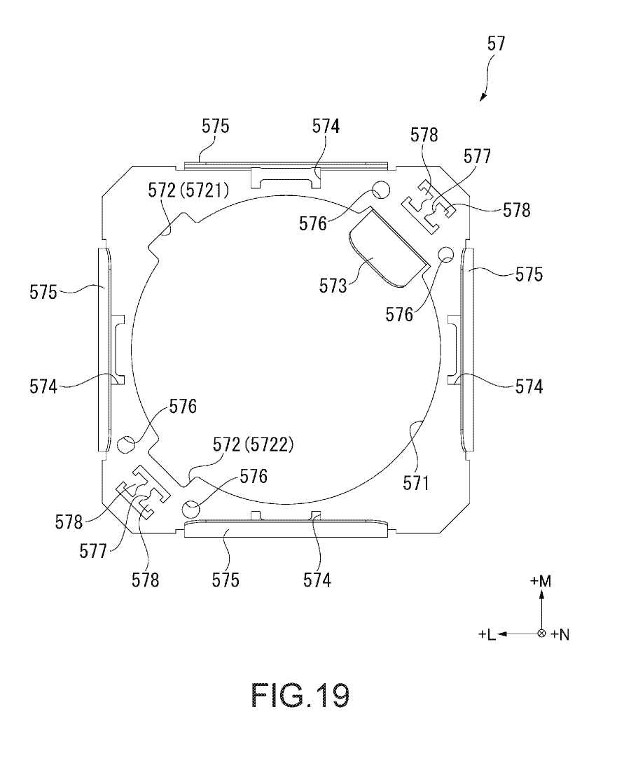

FIG. 19 is a diagram of the fixing member 57 viewed from the −N-direction side.

The fixing member 57 is fixed to the intermediate member 53 by the screws SC2 while pressing the reflector 562 against the intermediate member 53. As shown in FIGS. 13, 14, and 19, the fixing member 57 is formed by bending a sheet metal and has a substantially square shape when viewed from the −N-direction side.

Such a fixing member 57 includes an opening section 571, concave sections 572, a pressing section 573, opening sections 574, expanding/reducing sections 575, positioning holes 576, insert-through holes 577, and flexible sections 578.

The opening section 571 is formed in a substantially circular shape substantially in the center of the fixing member 57. A part on the −N-direction side of the reflector 562 is inserted into the opening section 571. Note that an inner diameter dimension of the opening section 571 is set smaller than an outer diameter dimension of the reflector 562. Therefore, when the part on the −N-direction side of the reflector 562 is inserted into the opening section 571, the annular section 5621 is brought into contact with the end edge of the opening section 571.

The concave sections 572 are formed at the end edge of the opening section 571 and in positions corresponding to two of the four corner sections of the fixing member 57. Specifically, the two concave sections 572 are formed in positions 90° apart from each other when centering on the center of the opening section 571. In other words, a first concave section 5721 of the two concave sections 572 is formed in a position corresponding to the corner section on the +L-direction side and the +M-direction side at the end edge of the opening section 571. A second concave section 5722 is formed in a position corresponding to the corner section on the +L-direction side and the −M-direction side at the end edge of the opening section 571. The convex sections 5622 fit in the concave sections 5721 and 5722 when the reflector 562 is inserted into the opening section 571. Consequently, the reflector 562 having a circular shape is suppressed from rotating about a rotation axis extending along the +N direction in a state in which the reflector 562 is engaged with the fixing member 57.

The pressing section 573 is an urging section (a leaf spring section) that presses and urges the reflector 562, which is inserted into the opening section 571, toward the end edge of the opening section 571 and regulates the swing of the reflector 562. The pressing section 573 is disposed in a position on the opposite side of the second concave section 5722 (a position on the −L-direction side and the M-direction side) at the end edge of the opening section 571. Such a pressing section 573 presses and urges the reflector 562 to the second concave section 5722 side.

The opening sections 574 are formed in substantially the centers of the side edges of the fixing member 57 when viewed from the −N-direction side. The projecting sections 539 of the intermediate member 53 are inserted into the four opening sections 574. That is, the opening sections 574 are insertion sections into which the projecting sections 539 are inserted.

The expanding/reducing sections 575 are located at the side edges of the fixing member 57 and extend to the −N-direction side. Apart of the expanding/reducing sections 575 form the end edges on the outer side in the opening sections 574 (the outer side with respect to the center of the fixing member 57). Therefore, when the expanding/reducing sections 575 are bent to the center side of the fixing member 57 (turned to the center side about the side edges), the opening sections 574 are expanded in diameter. When the expanding/reducing sections 575 are returned to the original state thereof in a state in which the opening sections 574 are expanded in diameter, the opening sections 574 are reduced in diameter.

In a state in which the expanding/reducing sections 575 are operated and the opening sections 574 are expanded in diameter in this way, the projecting sections 539 are inserted into the opening sections 574. In a state in which the corresponding projecting sections 539 are inserted into the opening sections 574, when the positions of the expanding/reducing sections 575 are returned to the original positions by, for example, releasing a hand, the opening sections 574 are reduced in diameter and the projecting sections 539 are held by the end edges of the corresponding opening sections 574. Consequently, the fixing member 57 is provisionally fixed to the intermediate member 53.

Note that the distal end portion of each of the four expanding/reducing sections 575 inclines to the center side. It is easy to bend the expanding/reducing section 575 gripped by the user. The expanding/reducing sections 575 also function as blocking sections that block an ultraviolet ray and an infrared ray passed through the reflector 562.

The positioning holes 576 are formed in positions corresponding to the positioning sections 537 of the intermediate member 53. The positioning sections 537 are inserted into the positioning holes 576. Consequently, the fixing member 57 is positioned with respect to the intermediate member 53.

The insert-through holes 577 and pairs of flexible sections 578 are respectively formed by cutout in the vicinities of two corner sections located on the same diagonal line in the fixing member 57.

The screws SC2 for fixing the fixing member 57 to the intermediate member 53 are inserted through the insert-through holes 577 of the insert-through holes 577 and the pairs of flexible sections 578 from the −N-direction side.

The pairs of flexible sections 578 form the end edges of the insert-through holes 577 with parts of the end edges opposed to each other of the pairs of flexible sections 578. The pairs of flexible sections 578 have flexibility to the ±N direction centering on the end portions on the opposite side of the insert-through holes 577, that is, connecting parts to the fixing member 57. Therefore, even when the positions of the insert-through holes 577, through which the screws SC2 are inserted, and the positions of the screw holes 536, in which the screws SC2 are screwed in the intermediate member 53, deviate because of, for example, dimension tolerance of a component, since the pairs of flexible sections 578 bend, it is possible to adjust the positions of the insert-through holes 577 and align the positions of the insert-through holes 577 and the positions of the screw holes 536.

### Attachment of the Light Source and the Fixing Member to the Intermediate Member

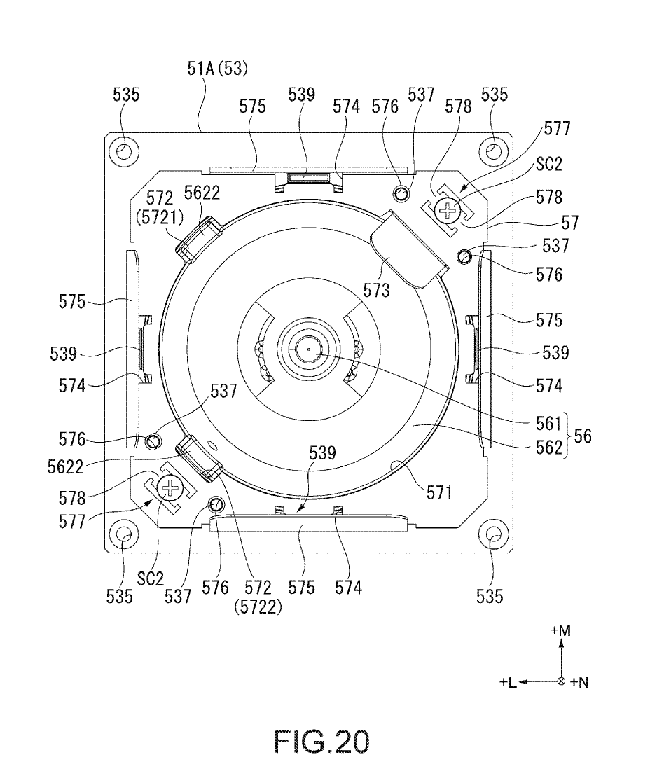

FIG. 20 is a diagram of the intermediate member 53 attached with the light source 56 and the fixing member 57 viewed from the −N-direction side.

When the light source 56 is fixed to the intermediate member 53 by the fixing member 57, the light source 56 is fixed according to a procedure explained below.

First, a part of the reflector 562 is inserted into the opening section 571 of the fixing member 57. The two convex sections 5622 of the reflector 562 are fit in the concave sections 572 of the fixing member 57. In this state, the opening end edge of the reflector 562 is fit in the step section 538 of the intermediate member 53 and the positioning sections 537 are inserted into the positioning holes 576 to attach the fixing member 57 to the intermediate member 53 from the −N-direction side.

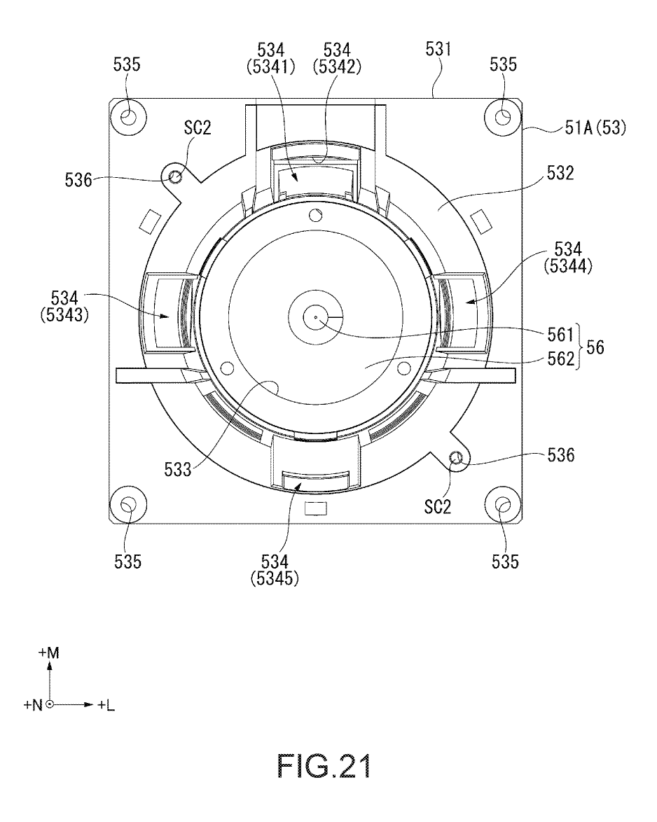

FIG. 21 is a diagram of the intermediate member 53 attached with the light source 56 and the fixing member 57 viewed from the +N-direction side. Note that, in FIG. 21, the collimating lens 54 and the pressing member 55 fixed to the intermediate member 53 are not shown.

In a state in which the expanding/reducing sections 575 are bent and the opening sections 574 are expanded in diameter in the fixing member 57, the projecting sections 539 are inserted into the opening sections 574. The opening sections 574 are reduced in diameter by returning the expanding/reducing sections 575 to the original state. The projecting sections 539 are held by the end edges of the opening sections 574. Consequently, the fixing member 57 and the light source 56 are provisionally fixed to the intermediate member 53.

Thereafter, the two screws SC2 are inserted into the insert-through holes 577 corresponding to the screws SC2 from the −N-direction side and further screwed in the screw holes 536 formed in the intermediate member 53. Consequently, as shown in FIGS. 20 and 21, the fixing member 57 and the light source 56 are fixed to the intermediate member 53.

### Assembly of the Light Source Device

When the light source device 5 is assembled, for example, as shown in FIG. 11, the first housing 511 (the emission side housing 51A), in which the housing section 5112 disposed with the light blocking member 52 is closed by the intermediate member 53, and the second housing 512 (the proximal-end side housing 51B) attached with the light blocking member 58 and the terminal section 513 are fixed by the screws SC1. When the first housing 511 and the second housing 512 are fixed by the screws SC1, the screws SC1 are inserted into the insertion holes 511A of the first housing 511 from the +N-direction side along the −N direction and screwed in the screw holes 5123 of the second housing 512.

Consequently, the light source device 5 is assembled.

### Attachment of the Light Source Device to the Light-Source Attaching Member

The light source device 5 is attached to the light-source attaching member 6 as explained above.

For example, as shown in FIGS. 5 and 6, the light source devices 5A and 5B are attached to the attaching sections 6A2 of the light-source attaching member 6A along the −X direction. The light source devices 5A and 5B are fixed to the attaching sections 6A2 when the screws SR (see FIGS. 11 and 12) inserted through the hole sections 5119 formed in the projecting sections 5118 along the −X direction are screwed with screw holes (not shown in the figure) of the bosses 6A6 protrudingly provided in the attaching sections 6A2.

When the light source devices 5C and 5D are fixed to the attaching section of the light-source attaching member 6B, similarly, the light source devices 5C and 5D are attached and fixed to the attaching section along the +X direction.

That is, the light source devices 5A and 5B are fixed to the light-source attaching member 6A by the screws SR inserted along the +N direction for the light source devices 5A and 5B. The light source devices 5C and 5D are fixed to the light-source attaching members 6B by the screws SR inserted along the +N direction for the light source devices 5C and 5D.

In this way, an inserting direction of the screws SR for fixing the light source device 5 to the light-source attaching member 6 and an inserting direction of the screws SC1 for fixing the first housing 511 and the second housing 512 are opposite directions each other. An insertion side of the screws SR and an insertion side of the screws SC1 into the light source device 5 are opposite sides each other. In other words, a removing direction of the screws SR from the light source device 5 and a removing direction of the screws SC1 from the light source device 5 are opposite directions each other. The surface 511F, on which the screws SC1 are disposed, is covered by the light-source attaching member 6. Therefore, when the light source device 5 is viewed from an attachment side of the light source device 5 to the light-source attaching member 6, that is, a removing side of the screws SR, the screws SC1 are not visually recognized.

Consequently, when the light source device 5 is detached from the light-source attaching member 6, it is possible to suppress a situation in which the screws SC1 are removed by mistake and the second housing 512 is separated from the first housing 511 while the first housing 511 is kept fixed to the light-source attaching member 6.

With the projector 1 according to this embodiment explained above, there are effects explained below.

The removing direction of the screws SR functioning as the first fixture for fixing the light source device 5 to the light-source attaching member 6 functioning as the attachment member and the removing direction of the screws SC1 functioning as the second fixture for fixing the first housing 511 and the second housing 512 are different. Consequently, in the example of the light source device 5 (5A, 5B) attached to the light-source attaching member 6A, as shown in FIG. 5, when the light source device 5 is viewed from the removing direction side of the screws SR (the +X-direction side), it is possible to make it difficult to visually recognize the screws SC1. The same holds true in the light source devices 5C and 5D attached to the light-source attaching member 6B. Therefore, when the screws SR are removed to detach the light source device 5 from the light-source attaching member 6, it is possible to suppress the screws SC1 from being removed by mistake. It is possible to appropriately detach the light source device 5 from the light-source attaching member 6.

The screws SR are inserted into the light source device 5 and the light-source attaching member 6 along the direction in which the light-source attaching member 6 is located with respect to the light source device 5 (the +N direction). The screws SC1 are inserted into the first housing 511 and the second housing 512 along the opposite direction of the inserting direction of the screws SR (−N direction). Consequently, as explained above, when the light source device 5 is viewed from the removing direction side of the screws SR (the −N-direction side), it is possible to make it more difficult to visually recognize the screws SC1. Consequently, it is possible to surely suppress the screws SC1 from being removed when the light source device 5 is detached from the light-source attaching member 6. Therefore, it is possible to appropriately detach the light source device 5 from the light-source attaching member 6.

The first housing 511 (the emission side housing 51A) is located on the light-source attaching member 6 side in the housing 51. The second housing 512 (the proximal-end side housing 51B) is located on the opposite side of the light-source attaching member 6 in the housing 51. The screws SR are inserted into the bosses of the light-source attaching member 6 (the bosses 6A6 in the light-source attaching member 6A) from the second housing 512 side. The screws SC1 are inserted into the second housing 512 from the first housing 511 side. Consequently, it is possible to surely set the respective inserting directions of the screws SR and SC1 to opposite directions each other. In other words, it is possible to surely set the respective removing directions of the screws SR and SC1 to opposite directions each other. Therefore, when the screws SR are removed, it is possible to more surely make it difficult to visually recognize the screws SC1. It is possible to surely suppress the screws SC1 from being removed.

The first housing 511 includes the insertion holes 511A, into which the screws SC1 are inserted, on the surface 511F opposed to the light-source attaching member 6. When the light source device 5 is attached to the light-source attaching member 6, the surface 511F and the screws SC1 inserted into the insertion holes 511A are covered by the light-source attaching member 6. Consequently, when the light source device 5 is detached from the light-source attaching member 6, it is possible to more surely suppress the screws SC1 from being visually recognized. Therefore, it is possible to more surely suppress the screws SC1 from being removed when the light source device 5 is detached. It is possible to appropriately detach the light source device 5 from the light-source attaching member 6.

When the hole sections, through which the screws SR fixed to the light-source attaching member 6 are inserted, are located in the second housing 512 apart from the light-source attaching member 6, a dimension between the hole sections and the light-source attaching member 6 is long. In such a case, it is necessary to adopt relatively long screws SR. Moreover, it is difficult to stably fix the light source device 5 to the light-source attaching member 6.

On the other hand, when the hole sections 5119, through which the screws SC1 inserted from the second housing 512 side and fixed to the light-source attaching member 6 are inserted, are located in the first housing 511, compared with the case described above, it is possible to reduce a dimension between the hole sections 5119 and the light-source attaching member 6. Therefore, it is possible to adopt relatively short screws SR. It is possible to stably fix the light source device 5 to the light-source attaching member 6.

The first housing 511 includes the projecting sections 5118 projecting further to the outer side than the second housing 512 when viewed from an attachment side of the light source device 5 to the light-source attaching member 6 (the −N-direction side; the +X-direction side in the light source devices 5A and 5B and the −X-direction side in the light source devices 5C and 5D). The hole sections 5119, through which the screws SR are inserted, are located in the projecting sections 5118. Consequently, on the attachment side of the light source device 5 to the light-source attaching member 6, it is possible to easily insert and remove the screws SR into and from the hole sections 5119 and it is possible to easily insert and remove the screws SR into and from the light-source attaching member 6. Therefore, it is possible to easily attach and detach the light source device 5 to and from the light-source attaching member 6.

The first housing 511 is located on the emission side of light emitted by the light source device 5 (the +N-direction side) with respect to the second housing 512. Consequently, since the light source device 5 is disposed such that the first housing 511 located on the light emission side in the light source device 5 is opposed to the light-source attaching member 6, it is possible to easily carry out adjustment of an emission position of light from the light source device 5 with respect to the light-source attaching member 6. Therefore, it is possible to easily and appropriately adjust a traveling direction of light emitted from the illumination device 31.

The illumination device 31 includes the light-source attaching member 6A to which the light source devices 5A and 5B are attached, the light-source attaching member 6B to which the light source devices 5C and 5D are attached, and the optical-path changing device 7 that changes optical paths of lights emitted from the light source devices 5A to 5D and emits the lights. Consequently, it is possible to align the lights emitted from the light source devices 5A to 5D in the +Z direction with the optical-path changing device 7 and emit the lights. Therefore, it is possible to make it easy to effectively use the lights emitted from the light source devices 5A to 5D. It is possible to increase the luminance of a projected image.

Note that, when the illumination device 31 includes one light-source attaching member 6 to which a plurality of light source devices 5 can be attached and when one light source device 5 is provided in each of the light-source attaching members 6, it is possible to align lights emitted from the light source devices 5 in the +Z direction with the optical-path changing device 7 and emit the lights. In these configurations, it is also possible achieve the effects explained above.

The fixing member 57 is attached to the intermediate member 53 configuring the emission side housing 51A in a state in which the reflector 562 is fixed. Consequently, it is possible to easily attach the reflector 562 to the intermediate member 53. Therefore, since it is possible to adopt a round reflector as the reflector 562, compared with when the square reflector is adopted, it is easy to condense reflected lights and align the reflected lights in one direction and equalize the thickness of the reflector 562. Therefore, it is possible to improve light use efficiency of light emitted from the light emitting section 5611. Besides, it is possible to improve easiness of manufacturing of the light source device 5.

The reflector 562 includes the convex sections 5622 projecting toward the outer side. The fixing member 57 includes the opening section 571 into which a part of the reflector 562 is inserted and the concave sections 572 that is located at the end edge of the opening section 571 and in which the convex sections 5622 fit. Consequently, when the end portion on the −N-direction side in the reflector 562 is inserted into the opening section 571 from the +N-direction side, since the convex sections 5622 fit in the concave sections 572, it is possible to suppress the rotation of the reflector 562 about the axis extending along the +N direction. Therefore, it is possible to stably attach the reflector 562 to the intermediate member 53.

The fixing member 57 includes the pressing section 573 that presses the reflector 562 to the concave sections 572 side in which the convex sections 5622 fit. Consequently, it is possible to surely suppress the swing and the rotation of the reflector 562. Therefore, it is possible to more stably fix the reflector 562.

The intermediate member 53 configuring the emission side housing 51A includes the projecting sections 539 that project to the fixing member 57 side. The fixing member 57 includes the opening sections 574, which are the insertion sections into which the projecting sections 539 are inserted. Consequently, it is possible to accurately position the fixing member 57, to which the reflector 562 is fixed, with respect to the intermediate member 53. Therefore, it is possible to attach the fixing member 57 and the reflector 562 to appropriate positions of the intermediate member 53 (the emission side housing 51A).

The fixing member 57 includes the expanding/reducing sections 575 that expand and reduce the inner diameter of the opening sections 574 and cause the end edges of the opening sections 574 to hold the projecting sections 539. Consequently, since the projecting sections 539 can be held by the end edges of the opening sections 574 expanded and reduced by the expanding/reducing sections 575, it is possible to provisionally fix the fixing member 57 to the intermediate member 53. Therefore, it is possible to more surely attach the fixing member 57 and the reflector 562 to appropriate positions of the intermediate member 53 (the emission side housing 51A). Besides, it is possible to easily perform a process for attaching the reflector 562 and the fixing member 57 to the intermediate member 53 (the emission side housing 51A).

The expanding/reducing sections 575 extend to the opposite side of the intermediate member 53 in the fixing member 57. When the expanding/reducing sections 575 are displaced to the center side of the fixing member 57 (the center side of the opening section 571), the opening sections 574 are expanded in diameter. When the expanding/reducing sections 575 are displaced to the opposite side of the center of the fixing member 57 (the outer side) (returns to the original positions), the opening sections 574 are reduced in diameter. Consequently, it is possible to easily expand and reduce the opening sections 574. It is possible to easily carry out operation for inserting the projecting sections 539 into the opening sections 574 and operation for causing the end edges of the opening sections 574 to hold the projecting sections 539 inserted into the opening sections 574. Therefore, it is possible to easily provisionally fix the fixing member 57 to the intermediate member 53.

The fixing member 57 includes the insert-through holes 577, through which the screws SC2 functioning as fixtures for fixing the fixing member 57 to the intermediate member 53, are inserted and the flexible sections 578 cut out and formed continuously to the insert-through holes 577 and forming the end edges of the insert-through holes 577. Consequently, even when tolerance occurs in a component dimension of at least one of the fixing member 57 and the intermediate member 53, since the flexible sections 578 bend, it is possible to align the positions of the insert-through holes 577 with the positions of the screw holes 546 and absorb the tolerance. Therefore, it is possible to surely attach the fixing member 57 to the intermediate member 53.

The emission-side housing 51A includes the first housing 511 functioning as a main body section combined with the second housing 512 of the proximal-end side housing 51B and the intermediate member 53 to which the light source 56 and the fixing member 57 are attached. The intermediate member 53 includes the air guide section 532 disposed on the inner side of the first housing 511 to guide the cooling gas to the light-emitting section 5611 of the luminous tube 561. The air guide section 532 includes the step section 538 in which the opening end edge of the reflector 562 is fit. Consequently, it is possible to suppress a leak of the cooling gas guided by the air guide section 532. It is possible to efficiently guide the cooling gas to the light emitting section 5611. Therefore, it is possible to improve cooling efficiency of the light emitting section 5611.

In a state in which the reflector 562 is fixed to the fixing member 57, the fixing member 57 is attached to the intermediate member 53 configuring the emission side housing 51A. Consequently, it is possible to easily attach the reflector 562 to the intermediate member 53. Therefore, since a round reflector can be adopted as the reflector 562, compared with when a square reflector is adopted, it is easy to condense reflected lights and align the reflected lights in one direction and equalize the thickness of the reflector 562. Therefore, it is possible to improve light use efficiency of light emitted from the light emitting section 5611. Besides, it is possible to improve easiness of manufacturing of the light source device 5.

The reflector 562 includes the convex sections 5622 projecting to the outer side. The fixing member 57 includes the opening section 571 into which a part of the reflector 562 is inserted and the concave sections 572 that are located at the end edge of the opening section 571 and in which the convex sections 5622 fit. Consequently, when the end portion on the −N-direction side in the reflector 562 is inserted into the opening section 571 from the +N-direction side, since the convex sections 5622 fit in the concave sections 572, it is possible to suppress the rotation of the reflector 562 about the axis extending along the +N direction. Therefore, it is possible to stably attach the reflector 562 to the intermediate member 53.

The fixing member 57 includes the pressing section 573 that presses the reflector 562 to the concave sections 572 side in which the convex sections 5622 fit. Consequently, it is possible to surely suppress the swing and the rotation of the reflector 562. Therefore, it is possible to more stably fix the reflector 562.

The intermediate member 53 configuring the emission side housing 51A includes the projecting sections 539 projecting to the fixing member 57 side. The fixing member 57 includes the opening sections 574, which are insertion sections into which the projecting sections 539 are inserted. Consequently, it is possible to accurately position the fixing member 57, to which the reflector 562 is fixed, with respect to the intermediate member 53. Therefore, it is possible to attach the fixing member 57 and the reflector 562 to appropriate positions of the intermediate member 53 (the emission side housing 51A).

The fixing member 57 includes the expanding/reducing sections 575 that expand and reduce the inner diameter of the opening sections 574 and cause the end edges of the opening sections 574 to hold the projecting sections 539. Consequently, since the projecting sections 539 can be held by the end edges of the opening sections 574 expanded and reduced by the expanding/reducing sections 575, it is possible to provisionally fix the fixing member 57 to the intermediate member 53. Therefore, it is possible to more surely attach the fixing member 57 and the reflector 562 to appropriate positions of the intermediate member 53 (the emission side housing 51A). Besides, it is possible to easily perform a process for attaching the reflector 562 and the fixing member 57 to the intermediate member 53 (the emission side housing 51A).

The expanding/reducing sections 575 extend to the opposite side of the intermediate member 53 in the fixing member 57. When the expanding/reducing sections 575 are displaced to the center side of the fixing member 57 (the center side of the opening section 571), the opening sections 574 are expanded in diameter. When the expanding/reducing sections 575 are displaced to the opposite side of the center of the fixing member 57 (the outer side) (returns to the original positions), the opening sections 574 are reduced in diameter. Consequently, it is possible to easily expand and reduce the opening sections 574. It is possible to easily carry out operation for inserting the projecting sections 539 into the opening sections 574 and operation for causing the end edges of the opening sections 574 to hold the projecting sections 539 inserted into the opening sections 574. Therefore, it is possible to easily provisionally fix the fixing member 57 to the intermediate member 53.

The fixing member 57 includes the insert-through holes 577, through which the screws SC2 functioning as fixtures for fixing the fixing member 57 to the intermediate member 53, are inserted and the flexible sections 578 cut out and formed continuously to the insert-through holes 577 and forming the end edges of the insert-through holes 577. Consequently, even when tolerance occurs in a component dimension of at least one of the fixing member 57 and the intermediate member 53, since the flexible sections 578 bend, it is possible to align the positions of the insert-through holes 577 with the positions of the screw holes 546 and absorb the tolerance. Therefore, it is possible to surely attach the fixing member 57 to the intermediate member 53.

The emission-side housing 51A includes the first housing 511 functioning as a main body section combined with the second housing 512 of the proximal-end side housing 51B and the intermediate member 53 to which the light source 56 and the fixing member 57 are attached. The intermediate member 53 includes the air guide section 532 disposed on the inner side of the first housing 511 to guide the cooling gas to the light-emitting section 5611 of the luminous tube 561. The air guide section 532 includes the step section 538 in which the opening end edge of the reflector 562 is fit. Consequently, it is possible to suppress a leak of the cooling gas guided by the air guide section 532. It is possible to efficiently guide the cooling gas to the light emitting section 5611. Therefore, it is possible to improve cooling efficiency of the light emitting section 5611.

The removing direction of the screws SR functioning as the first fixture for fixing the light source device 5 to the light-source attaching member 6 functioning as the attachment member and the removing direction of the screws SC1 functioning as the second fixture for fixing the first housing 511 and the second housing 512 are different. Consequently, in the example of the light source device 5 (5A and 5B) attached to the light-source attaching member 6A, as shown in FIG. 5, when the light source device 5 is viewed from the removing direction side of the screws SR (the +X-direction side), it is possible to make it difficult to visually recognize the screws SC1. The same holds true in the light source devices 5C and 5D attached to the light-source attaching member 6B. Therefore, when the screws SR are removed to detach the light source device 5 from the light-source attaching member 6, it is possible to suppress the screws SC1 from being removed by mistake. It is possible to appropriately detach the light source device 5 from the light-source attaching member 6.

The screws SR are inserted into the light source device 5 and the light-source attaching member 6 along the direction in which the light-source attaching member 6 is located with respect to the light source device 5 (the +N direction). The screws SC1 are inserted into the first housing 511 and the second housing 512 along the opposite direction of the inserting direction of the screws SR (the −N direction). Consequently, as explained above, when the light source device 5 is viewed from the removing direction side of the screws SR (the −N-direction side), it is possible to make it more difficult to visually recognize the screws SC1. Consequently, it is possible to surely suppress the screws SC1 from being removed when the light source device 5 is detached from the light-source attaching member 6. Therefore, it is possible to appropriately detach the light source device 5 from the light-source attaching member 6.

The first housing 511 (the emission side housing 51A) is located on the light-source attaching member 6 side in the housing 51. The second housing 512 (the proximal-end side housing 51B) is located on the opposite side of the light-source attaching member 6 in the housing 51. The screws SR are inserted into the bosses of the light-source attaching member 6 (the bosses 6A6 in the light-source attaching member 6A) from the second housing 512 side. The screws SC1 are inserted into the second housing 512 from the first housing 511 side. Consequently, it is possible to surely set the respective inserting directions of the screws SR and SC1 to opposite directions each other. In other words, it is possible to surely set the respective removing directions of the screws SR and SC1 to opposite directions each other. Therefore, when the screws SR are removed, it is possible to more surely make it difficult to visually recognize the screws SC1. It is possible to surely suppress the screws SC1 from being removed.

The first housing 511 includes the insertion holes 511A, into which the screws SC1 are inserted, on the surface 511F opposed to the light-source attaching member 6. When the light source device 5 is attached to the light-source attaching member 6, the surface 511F and the screws SC1 inserted into the insertion holes 511A are covered by the light-source attaching member 6. Consequently, when the light source device 5 is detached from the light-source attaching member 6, it is possible to more surely suppress the screws SC1 from being visually recognized. Therefore, it is possible to more surely suppress the screws SC1 from being removed when the light source device 5 is detached. It is possible to appropriately detach the light source device 5 from the light-source attaching member 6.

When the hole sections, through which the screws SR fixed to the light-source attaching member 6 are inserted, are located in the second housing 512 apart from the light-source attaching member 6, a dimension between the hole sections and the light-source attaching member 6 is long. In such a case, it is necessary to adopt relatively long screws SR. Moreover, it is difficult to stably fix the light source device 5 to the light-source attaching member 6.

On the other hand, when the hole sections 5119, through which the screws SC1 inserted from the second housing 512 side and fixed to the light-source attaching member 6 are inserted, are located in the first housing 511, compared with the case described above, it is possible to reduce a dimension between the hole sections 5119 and the light-source attaching member 6. Therefore, it is possible to adopt relatively short screws SR. It is possible to stably fix the light source device 5 to the light-source attaching member 6.

The first housing 511 includes the projecting sections 5118 projecting further to the outer side than the second housing 512 when viewed from an attachment side of the light source device 5 to the light-source attaching member 6 (the −N-direction side; the +X-direction side in the light source devices 5A and 5B and the −X-direction side in the light source devices 5C and 5D). The hole sections 5119, through which the screws SR are inserted, are located in the projecting sections 5118. Consequently, on the attachment side of the light source device 5 to the light-source attaching member 6, it is possible to easily insert and remove the screws SR into and from the hole sections 5119 and it is possible to easily insert and remove the screws SR into and from the light-source attaching member 6. Therefore, it is possible to easily attach and detach the light source device 5 to and from the light-source attaching member 6.

The first housing 511 is located on the emission side of light emitted by the light source device 5 (the +N-direction side) with respect to the second housing 512. Consequently, since the light source device 5 is disposed such that the first housing 511 located on the light emission side in the light source device 5 is opposed to the light-source attaching member 6, it is possible to easily carry out adjustment of an emission position of light from the light source device 5 with respect to the light-source attaching member 6. Therefore, it is possible to easily and appropriately adjust a traveling direction of light emitted from the illumination device 31.

The illumination device 31 includes the light-source attaching member 6A to which the light source devices 5A and 5B are attached, the light-source attaching member 6B to which the light source devices 5C and 5D are attached, and the optical-path changing device 7 that changes optical paths of lights emitted from the light source devices 5A to 5D and emits the lights. Consequently, it is possible to align the lights emitted from the light source devices 5A to 5D in the +Z direction with the optical-path changing device 7 and emit the lights. Therefore, it is possible to make it easy to effectively use the lights emitted from the light source devices 5A to 5D. It is possible to increase the luminance of a projected image.

Note that, when the illumination device 31 includes one light-source attaching member 6 to which a plurality of light source devices 5 can be attached and when one light source device 5 is provided in each of the light-source attaching members 6, it is possible to align lights emitted from the light source devices 5 in the +Z direction with the optical-path changing device 7 and emit the lights. In these configurations, it is also possible achieve the effects explained above.

### Modifications of the Embodiment

The invention is not limited to the embodiment. Modifications, improvements, and the like in a range in which the object of the invention can be attained are included in the invention.

In the embodiment, the light source device 5 is attached to the light-source attaching member 6 inserted and removed into and from the exterior housing 2. However, the invention is not limited to this. That is, the attachment member, to which the light source device 5 is attached, may be a light-source attaching member (a light-source housing member) fixed in the exterior housing 2. The light-source attaching member 6 does not have to be configured such that the plurality of light source devices are detachably attachable to the light-source attaching member 6. The number of light source devices 5 attachable to the light-source attaching member 6 may be any number. Further, two light-source attaching members 6 may not be provided in the projector 1. The number of light-source attaching members 6 may be one or may be three or more.

In the embodiment, the screws SR are adopted as the fixtures for fixing the light source device 5 to the light-source attaching member 6. The screws SC1 are adopted as the fixtures for fixing the first housing 511 and the second housing 512 configuring the housing 51 of the light source device 5. Further, the screws SC2 are adopted as the fixtures for fixing the fixing member 57 to the intermediate member 53. However, the invention is not limited to this. That is, the fixtures may be other fastening members such as bolts.

In the embodiment, the screws SR are inserted through the hole sections 5119 of the light source device 5 along the +N direction and screw in the attaching sections of the light-source attaching member 6. The screws SC1 are inserted through the insertion holes 511A of the first housing 511 in the −N direction and screw in the screw holes 5123 of the second housing 512. However, the invention is not limited to this. That is, the inserting direction (the removing direction) of the fixtures into (from) the light-source attaching member 6 and the inserting direction (the removing direction) of the fixtures into (from) the housing 51 are not limited to the opposite directions each other and only have to be different. For example, the inserting directions (the removing directions) of the fixtures may be orthogonal.

In the embodiment, the first housing 511 includes the insertion holes 511A, through which the screws SC1 are inserted, on the surface 511F covered by the light-source attaching member 6 when the light source device 5 is attached to the light-source attaching member 6. However, the invention is not limited to this. That is, the surface 511F, on which the insertion holes 511A are formed, does not have to be covered by the light-source attaching member 6. The insertion holes 511A may be located on other surfaces.

In the embodiment, the first housing 511 includes the hole sections 5119 through which the screws SR for fixing the light source device 5 to the light-source attaching member 6 are inserted. The second housing 512 do not include such hole sections. However, the invention is not limited to this. That is, the hole sections, through which the screws SR are inserted, may be formed in only the second housing 512 or may be formed in each of the first housing 511 and the second housing 512.

In the embodiment, the projecting sections 5118, in which the hole sections 5119 are formed in the first housing 511, project further to the +M direction and the −M direction than the second housing 512 when viewed from the −N-direction side. However, the invention is not limited to this. For example, the projecting sections 5118 may project to at least one of the +L-direction side and the −L-direction side. Apart where the hole sections 5119 are formed in the first housing 511 may be formed larger than the second housing 512. Alternatively, the hole sections 5119 may be formed in positions covered by the second housing 512.

In the embodiment, the light source device 5 is attached to the light-source attaching member 6 such that the first housing 511 is disposed on the light-source attaching member 6 side with respect to the second housing 512. However, the invention is not limited to this. For example, the light source device may be attached to the light-source attaching member such that the second housing is located further on the light-source attaching member side than the first housing. That is, for example, in the example shown in FIG. 5, the light source device 5 (5A, 5B) may be attached to the light-source attaching member 6A such that the emitting direction of light is the +X direction. In this case, the removing direction of the fixtures (the screws SR) for fixing the light source device 5 to the light-source attaching member 6 only has to be set to a direction along the +X direction (the +N direction). The removing direction of the fixtures (the screws SC1) for fixing the first housing 511 and the second housing 512 only has to be set to a direction along the −X direction (the −N direction).

In the embodiment, the illumination device 31 includes the optical-path changing device 7 that aligns the lights emitted from the plurality of light source devices 5 (5A to 5D) in the +Z direction and emits the lights. However, the invention is not limited to this. The optical-path changing device does not have to be provided. The configuration of the optical-path changing device is not limited to the configuration of the optical-path changing device 7.

In the embodiment, the light source 56 (the reflector 562) is attached and fixed to, by the fixing member 57, the intermediate member 53 configuring the emission side housing 51A. However, the invention is not limited to this. For example, the light source 56 (the reflector 562) may be attached and fixed to the first housing 511 by the fixing member 57. That is, a member to which the reflector 562 is attached may be any member as long as the reflector 562 is attached and fixed to, by the fixing member, the emission side housing located on the emission direction side of light reflected by the reflector 562.

In the embodiment, the housing 51 is configured by combining the emission side housing 51A and the proximal-end side housing 51B. However, the invention is not limited to this. The proximal-end side housing 51B does not have to be provided.

In the embodiment, the reflector 562 includes the two convex sections 5622. The fixing member 57, into the opening section 571 of which the reflector 562 is inserted, includes the two concave sections 572, in which the two convex sections 5622 are fit, at the end edge of the opening section 571. However, the invention is not limited to this. That is, the number of convex sections 5622 is not limited to two. The number of concave sections 572, into which the convex sections 5622 are inserted, is not limited to two either. For example, the reflector 562 may include one convex section 5622. The fixing member 57 may include one concave section 572. The fixing member may include the convex sections and the reflector may include the concave sections. Further, if the rotation of the reflector 562 is suppressed by another component (e.g., the pressing section 573), the convex sections and the concave sections do not have to be provided.

In the embodiment, the fixing member 57 includes, at the end edge of the opening section 571, the pressing section 573 that presses and urges the reflector 562 to the concave sections 572 side in which the convex sections 5622 fit. However, the invention is not limited to this. For example, the position of the pressing section 573 is not limited to the end edge of the opening section 571 and may be another part. The pressing direction of the reflector 562 by the pressing section 573 may be another direction. For example, the pressing direction may be the concave sections 572 side located on the +L-direction side and the +M-direction side or may be the +L-direction side, the +M-direction side, or the −M-direction side. In these directions, the swing of the reflector 562 is regulated while a state in which the convex sections 5622 fit in the concave sections 572 is maintained.

In the embodiment, the four projecting sections 539 formed in the intermediate member 53 are inserted into the opening sections 574 corresponding to the projecting sections 539 in the fixing member 57 and are held by the end edges of the opening sections 574. Consequently, the fixing member 57 is provisionally fixed to the intermediate member 53. However, the invention is not limited to this. For example, the number of projecting sections 539 and opening sections 574 and the number of expanding/reducing sections 575 are not limited to four and can be changed as appropriate. Disposition positions of these sections can also be changed as appropriate. Note that, if at least pairs of the projecting sections 539, the opening sections 574, and the expanding/reducing sections 575 are provided in positions across the center of the opening section 571, the fixing member 57 is stably provisionally fixed.

When the projecting sections 539 and the opening sections 574 are used for the positioning of the fixing member 57 with respect to the intermediate member 53, the projecting sections 539 do not have to be held by the end edges of the opening sections 574. In this case, the expanding/reducing sections 575 can be omitted.

In the embodiment, in the fixing member 57, the insert-through holes 577, through which the screws SC2 screwing in the intermediate member 53 to fix the fixing member 57 to the intermediate member 53 are inserted, and the pair of flexible sections 578 forming the end edges of the insert-through holes 577, are formed by cutout. However, the invention is not limited to this. For example, the pair of flexible sections 578 does not have to be provided. By setting an inner diameter dimension of the insert-through holes 577 large in a range in which the inner diameter dimension is smaller than an outer diameter dimension of the heads of the screws SC2, tolerance of the component dimensions may be absorbed.

In the embodiment, the step section 538, in which the opening end edge of the reflector 562 is fit, is formed on the inner side of the air guide section 532 in the intermediate member 53. However, the invention is not limited to this. For example, such a step section 538 does not have to be provided.

In the embodiment, the light source 56 includes the luminous tube 561 and the reflector 562. However, the invention is not limited to this. For example, a solid-state light source such as an LED (Light Emitting Diode) or an LD (Laser Diode) may be adopted instead of the luminous tube 561. Concerning the difference between the removing direction of the screws SR for fixing the light source device 5 to the light-source attaching member 6 and the removing direction of the screws SC1 for fixing the first housing 511 and the second housing 512 configuring the housing 51 of the light source device 5, the reflector 562 may be the square reflector rather than the circular reflector.

In the embodiment, the liquid crystal panels 341 (341R, 341G, and 341B) of a transmission type are used as the light modulating devices. However, the invention is not limited to this. Liquid crystal panels of a reflection type may be adopted as the light modulating devices. In this case, the respective functions of the color separating device 33 and the color combining device 344 may be performed by one prism.

Further, it is also possible to adopt, as the light modulating devices, light modulating devices other than liquid crystal such as devices including micromirrors, for example, DMDs (Digital Micromirror Devices).

In the embodiment, the projector 1 includes the three liquid crystal panels 341. However, the invention is not limited to this. That is, the invention is also applicable to a projector including two or less or four or more liquid crystal panels.

In the embodiment, the disposition of the optical components configuring the image forming device 3 is the disposition shown in FIG. 2. However, the invention is not limited to this. For example, an image forming device configured in a substantial L-shape or a substantial U-shape may be adopted. The disposition of the optical components configuring the image forming device 3 and the types and the numbers of the optical components can be changed as appropriate.

In the embodiment, the example is explained in which the light source device and the illumination device of the invention are applied to the projector 1. However, the invention is not limited to this. It is also possible to apply the light source device and the illumination device of the invention as, for example, light source devices of a luminaire and an automobile.

What is claimed is:

1. An illumination device comprising:
a light source device;
an attachment member to which the light source device is attached; and
a first fixture inserted into the light source device and the attachment member to fix the light source device and the attachment member, wherein
the light source device includes:
a light source; and
a housing configured to house the light source on an inside,
the housing includes:
a first housing and a second housing combined with each other to house the light source on an inside; and
a second fixture inserted into the first housing and the second housing to fix the first housing and the second housing, and
a removing direction of the first fixture and a removing direction of the second fixture with respect to the light source device are different.

2. The illumination device according to claim 1, wherein
the first fixture is inserted into the light source device and the attachment member along a direction in which the attachment member is located with respect to the light source device, and
the second fixture is inserted into the first housing and the second housing along an opposite direction of the inserting direction of the first fixture.

3. The illumination device according to claim 2, wherein
the first housing is located on the attachment member side in the housing,
the second housing is located on an opposite side of the attachment member in the housing,
the first fixture is inserted into the attachment member from the second housing side, and
the second fixture is inserted into the second housing from the first housing side.

4. The illumination device according to claim 3, wherein
the first housing includes, on a surface opposed to the attachment member, an insertion hole into which the second fixture is inserted, and
the second fixture inserted into the insertion hole is covered by the attachment member.

5. The illumination device according to claim 3, wherein the first housing includes a hole section through which the first fixture, which is inserted from the second housing side and fixed to the attachment member, is inserted.

6. The illumination device according to claim 5, wherein
the first housing includes a projecting section projecting further to an outer side than the second housing when viewed from an attachment side of the light source device to the attachment member, and
the hole section is located in the projecting section.

7. The illumination device according to claim 1, wherein the first housing is located on an emission side of light emitted by the light source device with respect to the second housing.

8. A projector comprising the illumination device according to claim 1.

9. A projector comprising the illumination device according to claim 2.

10. The projector according to claim 8, wherein
the illumination device includes a plurality of the light source devices, and
the projector further comprises an optical-path changing device configured to change optical paths of lights emitted from the plurality of light source devices and emit the lights.

11. A light source device comprising:
a light emitting section;
a reflector configured to reflect light made incident from the light emitting section;
a housing configured to house the light emitting section and the reflector on an inside; and
a fixing member configured to fix the reflector, wherein
the reflector is formed in a circular shape at an end edge when viewed from an emitting direction side of the light reflected and emitted by the reflector,
the housing includes:
an emission side housing located, with respect to the reflector, on an emitting direction side of the light reflected by the reflector; and
a proximal-end side housing located on an opposite side of the emitting direction of the light and combined with the emission side housing, and
the fixing member is attached to the emission side housing in a state in which the reflector is fixed.

12. The light source device according to claim 11, wherein
the reflector includes a convex section projecting toward an outer side, and
the fixing member includes:
an opening section into which the reflector is inserted; and
a concave section located at an end edge of the opening section, the convex section fitting in the concave section.

13. The light source device according to claim 12, wherein the fixing member includes a pressing section configured to press the reflector inserted into the opening section to the concave section side.

14. The light source device according to claim 11, wherein
the emission side housing includes a projecting section projecting to the fixing member side, and
the fixing member includes an insertion section into which the projecting section is inserted.

15. The light source device according to claim 14, wherein the fixing member includes an expanding/reducing section configured to expand and reduce the insertion section and cause an end edge of the insertion section to hold the projecting section.

16. The light source device according to claim 15, wherein
the expanding/reducing section extends to an opposite side of the emission side housing in the fixing member, and
the insertion section is expanded in diameter when the expanding/reducing section is displaced to a center side of the fixing member.

17. The light source device according to claim 11, wherein the fixing member includes:
an insert-through hole through which a fixture for fixing the fixing member to the emission side housing is inserted; and
a flexible section cut out and formed continuously to the insert-through hole, the flexible section forming an end edge of the insert-through hole.

18. The light source device according to claim 11, wherein
the emission side housing includes:
a main body section combined with the proximal-end side housing; and
an air guide section disposed on an inner side of the main body section and configured to guide a cooling gas to the light emitting section, and
the air guide section includes a step section in which an opening end edge of the reflector is fit.

19. A projector comprising the light source device according to claim 11.

20. A projector comprising the light source device according to claim 12.
